(19) United States
(12) Patent Application Publication
(10) Pub. No.: US 2019/0003245 A1
(43) Pub. Date: Jan. 3, 2019

(54) GAS FILLING ASSEMBLY MACHINE AND METHOD FOR AN INSULATED GLASS UNIT

(71) Applicant: PDS IG Holding LLC, Prairie Du Sac, WI (US)

(72) Inventor: Paul Trpkovski, Kailua Kona, HI (US)

(21) Appl. No.: 16/024,780

(22) Filed: Jun. 30, 2018

Related U.S. Application Data
(60) Provisional application No. 62/528,082, filed on Jul. 1, 2017.

(51) Int. Cl. E06B 3/677; E06B 3/66

(52) U.S. Cl. CPC E06B 3/6775; E06B 3/6612

(57) ABSTRACT

Embodiments include a method for replacing air with an interpane gas during manufacture of a sealed insulating glass unit (IGU). The method includes forming an unsealed IGU assembly defining an IGU passage for fluid communication between an interpane space and an ambient environment. The method can include moving components of the unsealed IGU assembly into an enclosure and assembling the components to form the unsealed IGU assembly within the vacuum enclosure. The method can also include sealing the enclosure around the unsealed IGU assembly; evacuating air from the enclosure; and introducing a first gas into the interpane space through the IGU passage. The method can also include introducing a second gas into the enclosure, wherein the second gas has a different composition than the first gas; and closing the IGU passage to seal the interpane space. Other embodiments are also included herein.

### CROSS-REFERENCE TO RELATED APPLICATIONS

This application claims the benefit of U.S. Provisional Application No. 62/528,082, filed Jul. 1, 2017, the content of which is herein incorporated by reference in its entirety.

This application is also related to U.S. Provisional Application No. 62/528,083, filed Jul. 1, 2017, and to a nonprovisional application claiming priority therefrom, titled “No-Chamber Gas Filling for an Insulated Glass Unit,” having attorney docket number 824.0012USU1, and being filed on Jun. 30, 2018, the even date herewith (hereinafter “the '12 application”). The contents of U.S. Provisional Application No. 62/528,083 and the '12 application are incorporated herein by reference in their entireties.

This application is also related to U.S. Ser. No. 62/528,089, filed Jul. 1, 2017, and to a nonprovisional application claiming priority therefrom, having the title “Filling and Sealing Device and Method for an Insulated Glass Unit,” having attorney docket number 824.0013USU1, and being filed on Jun. 30, 2018, the even date herewith (hereinafter “the '13 application”). The contents of U.S. 62/528,089 and the '13 application are incorporated herein by reference in their entireties.

This application is also related to U.S. application Ser. No. 15/640,512, filed on Jul. 1, 2017 (now U.S. Publ. No. 2017/0299121), which is a continuation-in-part of prior U.S. application Ser. No. 15/398,459, filed Jan. 4, 2017, which claims the benefit of U.S. Provisional Application No. 62/274,676, filed Jan. 4, 2016, each of the contents of which are herein incorporated by reference in their entireties.

### FIELD OF THE TECHNOLOGY

The present application relates to filling an insulating glass unit. More specifically, the present application relates to filling an insulating glass unit with a gas within an enclosure.

### BACKGROUND

In recent years, there has been an increased awareness on energy usage and conservation. As a result many governing bodies have released energy standards and regulations for buildings and construction materials. These standards and regulations frequently require more energy efficient systems and components.

One specific area of focus includes more efficient windows and doors. Many governing bodies have passed regulations that require windows and doors to have a minimum insulating value to limit the amount of energy lost through windows and doors. As a result, window and door manufacturers have needed to find ways to increase the insulating properties of their products. The materials and techniques used to produce more insulated windows and doors have resulted in an increased cost to manufacture the windows and doors.

Some techniques and systems have been developed to fill glass units with one or more insulating gases. For example, U.S. Pat. No. 8,627,856 discloses a method and apparatus wherein the insulating gases are supplied to gas filling tubes that are inserted into one or more interpane spaces of the insulating glass units. Each interpane space may be filled with more than one insulating gas. A control unit controls the injection of the insulating gases in accordance with gas filling data received by the control unit.

### SUMMARY

One general aspect includes a method for manufacturing a sealed insulating glass unit (IGU), including: providing a first sheet of glass material on a support structure in an interior of an open vacuum enclosure, the vacuum enclosure including a first portion, a second portion, and an assembly plate. The method also includes moving the first sheet away from the support structure with the assembly plate. The method also includes moving an IGU subassembly into the open vacuum enclosure, the IGU subassembly including a second sheet of glass material and a spacer frame sealed to the second sheet. The method also includes forming an unsealed IGU assembly within the vacuum enclosure, the unsealed IGU assembly including the first sheet at least partially sealed to the IGU subassembly, the unsealed IGU assembly defining an interpane space located between the first and second sheets and an IGU passage providing fluid communication between the interpane space and the interior of the vacuum enclosure. The method also includes sealing the first and second portions of the vacuum enclosure while the vacuum enclosure contains the first sheet and the IGU subassembly. The method also includes evacuating air from the sealed vacuum enclosure and from the unsealed IGU assembly. The method also includes introducing a gas into the interpane space through at least a portion of the IGU passage; and closing the IGU passage to seal the interpane space.

Implementations may include one or more of the following features. The method where the second portion of the vacuum enclosure is fixed and the first portion of the vacuum enclosure is movable relative to the second portion, and where moving the first sheet away from the support structure with the assembly plate includes moving the first sheet relative to the first portion. The method where moving the first sheet away from the support structure with the assembly plate includes lifting the first sheet with the assembly plate and moving the first sheet away from the support structure with the assembly plate. The method further including creating a vacuum between the assembly plate and the first sheet to hold the first sheet against the assembly plate before lifting the first sheet with the assembly plate. The method where forming the unsealed IGU assembly within the vacuum enclosure includes moving the first sheet next to the IGU subassembly with the assembly plate and removing the vacuum between the assembly plate and the first sheet, thereby positioning the first sheet on the support structure next to the IGU subassembly. The method where positioning the first sheet next to the IGU subassembly includes leaning the first sheet against the IGU subassembly. The method where removing the vacuum releases the first sheet onto the support structure such that a top edge of the first sheet contacts the IGU subassembly and a bottom edge of the first sheet is spaced apart from the IGU subassembly. The method where sealing the first and second portions of the vacuum enclosure occurs before forming the unsealed IGU assembly within the vacuum enclosure. The method where sealing the first and second portions of the vacuum enclosure occurs after forming the unsealed IGU assembly within the vacuum enclosure.

One general aspect includes a method for making an insulating glass unit (IGU) assembly, including: moving a first sheet of glass material onto a support structure in an interior of an open vacuum enclosure, the vacuum enclosure including a first portion, a second portion, and an assembly plate. The method also includes creating a vacuum between the assembly plate and the first sheet to hold the first sheet against the assembly plate. The method also includes lifting the first sheet with the assembly plate and moving the first sheet away from the support structure with the assembly plate. The method also includes moving an IGU subassembly onto the support structure within the open vacuum enclosure, the IGU subassembly including a second sheet of glass material and a spacer frame sealed to the second sheet; and forming an unsealed IGU assembly within the vacuum enclosure, including: The method also includes moving the first sheet with the assembly plate to be next to the IGU subassembly within the vacuum enclosure. The method also includes removing the vacuum between the assembly plate and the first sheet to position the first sheet on the support structure next to the IGU subassembly. The method also includes where the unsealed IGU assembly defines an interpane space located between the first and second sheets and an IGU passage providing fluid communication between the interpane space and the interior of the vacuum enclosure.

Implementations may include one or more of the following features. The method where forming the unsealed IGU assembly further includes pressing and sealing the first sheet against at least part of the IGU subassembly with the assembly plate. The method further including: sealing the first and second portions of the vacuum enclosure while the vacuum enclosure contains the first sheet and the IGU subassembly. The method may also include evacuating air from the sealed vacuum enclosure and from the unsealed IGU assembly. The method may also include introducing a gas into the interpane space through at least a portion of the IGU passage; and closing the IGU passage to seal the interpane space.

One general aspect includes a system for assembling and filling an insulating glass unit (IGU) with an interpane gas, including: a vacuum enclosure including a first portion and a second portion configured to selectively seal together to define a sealed interior of the vacuum enclosure. The system also includes a first vacuum source in selective fluid communication with the sealed interior of the vacuum enclosure. The system also includes a gas supply in selective fluid communication with the vacuum enclosure. The system also includes an assembly plate system, including an assembly plate carried by the first portion, and an actuating system coupled to the assembly plate. The system also includes where the second portion includes a support plate and a support structure adjacent to the support plate within the vacuum enclosure. The system also includes where the assembly plate system is configured to move a first sheet of glass material supported by the support structure within the vacuum enclosure away from the support structure. The system also includes where the support structure is configured to receive and support an IGU subassembly within the vacuum enclosure after the assembly plate system moves the first sheet away from the support structure, the IGU subassembly including a second sheet of glass material and a spacer frame sealed to the second sheet. The system also includes where the assembly plate system is configured to position the first sheet next to the IGU subassembly supported by the support structure as part of forming an unsealed IGU assembly. The system also includes where the unsealed IGU assembly includes the first sheet at least partially sealed to the IGU subassembly and defines an interpane space between the first and second sheets and an IGU passage providing fluid communication between the interpane space and the sealed interior of the vacuum enclosure. The system also includes where the selective fluid communication for the gas supply is configured for filling at least one of the sealed interior of the vacuum enclosure and the interpane space of the unsealed IGU assembly with the gas supply.

Implementations may include one or more of the following features. The system where the actuating system provides the assembly plate with a range of movement relative to the first portion, the second portion, and the support plate. The system where the assembly plate system further includes a second vacuum source in selective fluid communication with a plurality of openings in the assembly plate for creating a vacuum between the assembly plate and the first sheet. The system where the support plate is angled away from a vertical axis of the vacuum enclosure.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope of the present application is defined by the appended claims and their legal equivalents.

### BRIEF DESCRIPTION OF THE DRAWINGS

The technology may be more completely understood in connection with the drawings, in which:

FIG. 1 is a perspective view of an insulating glass unit (IGU), according to various embodiments.

FIG. 2 is a front schematic representation of a system for assembling and filling an IGU with an interpane gas, according to various embodiments.

FIG. 3 is a flow chart depicting a method for forming an unsealed IGU assembly, according to various embodiments.

FIG. 4 is a side schematic view of a system including a vacuum enclosure for assembling an unsealed IGU assembly, according to various embodiments.

FIGS. 5-10 are side schematic views of the system of FIG. 4 illustrating steps for assembling an unsealed IGU, according to various embodiments.

FIGS. 11-12 are a side schematic views of the system of FIG. 4 illustrating an IGU passage formed as a gap in the edge of an unsealed IGU assembly located within the vacuum enclosure, according to various embodiments.

FIGS. 13-14 are side schematic views of the system of FIG. 4 illustrating a filling device that provides an IGU passage for an unsealed IGU assembly located within the vacuum enclosure, according to various embodiments.

FIGS. 15-16 are cut away perspective views of an enclosure showing an actuator and connected filling device inserted into an unsealed IGU assembly, according to various embodiments.

FIG. 17 is a side view of the enclosure of FIG. 4 depicting an unsealed IGU assembly supported within the enclosure, according to various embodiments.

FIG. 18 is a side view of the enclosure of FIG. 4 with the enclosure open and an IGU ready to exit the enclosure, according to various embodiments.

FIGS. 19-21 are views showing steps in assembling an insulating glass unit assembly within an enclosure, according to various embodiments.

FIG. 22 is a top partial view of an insulating glass unit including a rivet for sealing the IGU, according to various embodiments.

FIGS. 23-29 show steps in assembling a triple pane IGU assembly, according to various embodiments.

FIG. 30 is a front view of an IGU gas filling system, according to various embodiments.

FIG. 31 is a left side view of the IGU gas filling system shown in FIG. 30, according to various embodiments.

FIG. 32 is a right perspective view of the IGU gas filling system shown in FIG. 30, according to various embodiments.

FIG. 33 is a perspective view of a gas filling ram, according to various embodiments.

While the technology is susceptible to various modifications and alternative forms, specifics thereof have been shown by way of example and drawings, and will be described in detail. It should be understood, however, that the application is not limited to the particular embodiments described. On the contrary, the application is to cover modifications, equivalents, and alternatives falling within the spirit and scope of the technology.

### DETAILED DESCRIPTION

The embodiments of the present technology described herein are not intended to be exhaustive or to limit the technology to the precise forms disclosed in the following detailed description. Rather, the embodiments are chosen and described so that others skilled in the art can appreciate and understand the principles and practices of the present technology.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

Embodiments described herein relate to methods and machines for manufacturing sealed insulating glass units (IGUs). In various embodiments, an insulating glass unit or IGU includes a first sheet of glass material and a second sheet of glass material. Some insulating glass units can further include a third sheet, such as a sheet of glass material. A spacer can separate the first sheet from the second sheet, and can extend around the insulating glass unit near the perimeter of the insulating glass unit. The first sheet, second sheet, and spacer define an interpane space or volume that can be initially filled with air, such as air from the ambient environment of the manufacturing facility. In various embodiments, the air can be replaced with a different gas, such as to increase or affect the insulating properties of the window. Various different gases have different insulating properties. Some varieties of IGUs have a first sheet, a second sheet, and an intermediate sheet between the first and second sheets and are referred to as triple pane IGUs. In some examples, two portions of an interpane space of a triple pane IGU are in fluid communication with each other through an opening in the intermediate sheet.

Generally speaking, various embodiments described herein include providing and/or positioning one or more components of an IGU inside a vacuum enclosure, also referred to herein as a vacuum chamber. In some examples, the components are assembled within the vacuum enclosure to form an unsealed IGU assembly. Inside the vacuum chamber, the unsealed IGU assembly can be evacuated of existing ambient air. The IGU assembly can then be filled with a gas providing one or more desirable features. In some implementations, the filled IGU assembly can then exit the vacuum enclosure and be sealed at some point outside the vacuum chamber. In some implementations, the filled IGU assembly may instead be sealed inside the chamber before exiting. In such cases, the vacuum enclosure may optionally be closed during sealing of the IGU or may be open in some cases.

The manufacture of insulating glass units (IGUs) is generally a complex process that can involve large, expensive, and complex pieces of manufacturing equipment. In some cases the need to use multiple pieces of large manufacturing equipment necessitates a larger than desired installation footprint. For example, some IGU manufacturing processes can involve multiple machines and stations, which must be spread out across a plant. The number of pieces of equipment, and their spatial arrangement, can in some cases result in assembly lines that are longer than desired.

Providing and assembling components of an IGU within an evacuation chamber can in some cases replace assembly steps that may otherwise occur outside of the vacuum enclosure. For example, one method of manufacturing a sealed IGU involves making a partially assembled IGU at one or more machine stations outside of the enclosure and then moving the partially assembled IGU into the enclosure for evacuation and filling with gas. According to various embodiments disclosed herein, a partially assembled IGU can instead be formed inside the vacuum chamber, removing the need for the same assembly stations outside the chamber. Assembling components of an IGU within the vacuum chamber can thus provide space saving benefits in some cases due to multiple operations being performed by a single station.

Various aspects and features described herein are directed to manufacturing a sealed insulating glass unit (IGU). According to various embodiments, a method of manufacturing a sealed IGU includes providing a first sheet of glass material. The first sheet is provided (e.g., placed, positioned, located) on a support structure within an open vacuum chamber, which is also referred to herein as a vacuum enclosure. The method further includes moving the first sheet away from the support structure. Moving the first sheet clears the support structure, providing room for moving an IGU subassembly into the open vacuum chamber and onto the support structure.

As used herein, the term “IGU subassembly” refers to one, two, three, or more assembled components of an IGU. According to various embodiments, an IGU subassembly includes a spacer that is sealed to a sheet of material. The sheet of material is glass in some cases. In some cases an IGU subassembly includes a spacer sealed to an intermediate pane, an additional spacer frame sealed to the opposite side of the intermediate pane, and sheet of glass sealed to the additional spacer frame for use in a triple pane IGU.

According to this implementation, the method includes forming, within the vacuum chamber, an unsealed IGU assembly from the first sheet and the IGU subassembly. The method also includes sealing the vacuum chamber while the first sheet and the IGU subassembly are contained therein. At some point in time after sealing the vacuum enclosure, air is evacuated from the sealed vacuum enclosure. The method also includes evacuating air from within the unsealed IGU assembly.

After evacuating air from the sealed vacuum enclosure and from the IGU, a gas can be introduced into the interpane space of the unsealed IGU assembly. According to an embodiment, the gas is introduced through at least a portion of an IGU passage of the unsealed IGU assembly. The method also includes closing the IGU passage to seal the interpane space.

According to various embodiments, a method for making an IGU assembly includes forming an unsealed IGU assembly within a vacuum enclosure. The method includes moving a first sheet of glass material onto a support structure within a vacuum enclosure. Once positioned within on the support structure, a vacuum is created between the assembly plate and the first sheet to hold the first sheet against the assembly plate. The method further includes lifting the first sheet with the assembly plate and moving the first sheet away from the support structure. Moving the first sheet from the support structure within the vacuum enclosure allows for moving an IGU subassembly onto the support structure. The unsealed IGU assembly is formed within the vacuum enclosure through steps that include moving the first sheet with the assembly plate to be next to the IGU subassembly and removing the vacuum to position the first sheet on the support structure next to the IGU subassembly. In some cases the method can further include using the assembly plate to press and seal the first sheet against at least part of the IGU subassembly. In some cases the first sheet pressed against at least part of the IGU subassembly forms the unsealed IGU assembly, which has an interpane space located between the first and second sheets and an IGU passage providing fluid communication between the interpane space and the interior of the vacuum enclosure.

Various embodiments provide a system for assembling and filling an IGU that will be described herein in further detail. Briefly, in some cases the system includes a vacuum enclosure having first and second portions that seal together. The system includes at least one vacuum source and at least one gas supply in communication with the sealed interior of the vacuum enclosure. An assembly plate system is provided within the vacuum enclosure and includes an actuating system coupled to the assembly plate for moving the assembly plate. A support plate and a support structure adjacent to the support plate are also located inside the vacuum enclosure for supporting sheets of glass and other components during assembly of an IGU.

According to various embodiments, the assembly plate system moves a first sheet of glass material away from the support structure and then positions the first sheet next to an IGU subassembly supported by the support structure. The support structure is configured to receive and support the IGU subassembly after the assembly plate system moves the first sheet away from the support structure. In some cases positioning the first sheet next to the IGU subassembly on the support structure forms the unsealed IGU assembly.

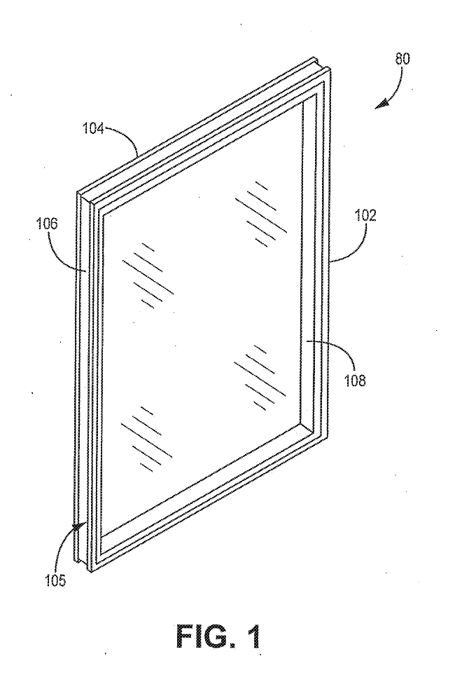

FIG. 1 is a perspective view of a completed, sealed insulating glass unit, according to an embodiment. The insulating glass unit 80, also referred to herein as an “IGU” 80, can include a first sheet 102 and a second sheet 104. The IGU 80 can include a spacer 106 disposed between the first sheet 102 and the second sheet 104. In an embodiment, the spacer 106 is slightly inset from the perimeter of the first sheet 102 and the second sheet 104. FIG. 1 shows an example of the spacer 106 being inset from the perimeter of the first sheet 102 and the perimeter of the second sheet 104. In various examples, a frame will be added around the perimeter of the IGU 80 prior to the IGU 80 being installed in a building or home.

The first sheet 102 and the second sheet 104 can include a translucent, transparent, or semi-transparent material, such as to allow light to pass through the two sheets 102, 104 or to allow a person to see through the two sheets 102, 104. In various embodiments, the first sheet 102 and the second sheet 104 include a glass material or glass or plastic, such as a clear or translucent glass or plastic. In various embodiments, the first sheet 102 and the second sheet 104 can be similar, such that the two sheets 102, 104 have a substantially similar shape and/or size.

The spacer 106 can be coupled to the first sheet 102 and the second sheet 104. The spacer 106 can extend from the first sheet 102 to the second sheet 104, such as to define a volume or an interpane space 108. The interpane space 108 is defined between the first sheet 102 and the second sheet 104. The spacer 106 also forms a boundary of the interpane space 108.

The spacer 106 is formed into a spacer frame 105 that surrounds the interpane space 108. The spacer frame 105 has a shape that matches the outer perimeter shape of the IGU 80. For example, where the IGU 80 is rectangular as in FIG. 1, the spacer frame 105 is a rectangle. In some embodiments, the spacer frame 105 can be generally rectangular, such as a rectangular shape with rounded corners. In various embodiments, the spacer frame 105 can have rounded corners and the outer perimeter of the IGU can be rectangular with square corners.

In various embodiments, a completed IGU 80 can be sealed, such as to trap an interpane gas within the interpane space 108. The sealed IGU 80 can retain the interpane gas within the interpane space 108 and prevent external gasses from entering the interpane space 108.

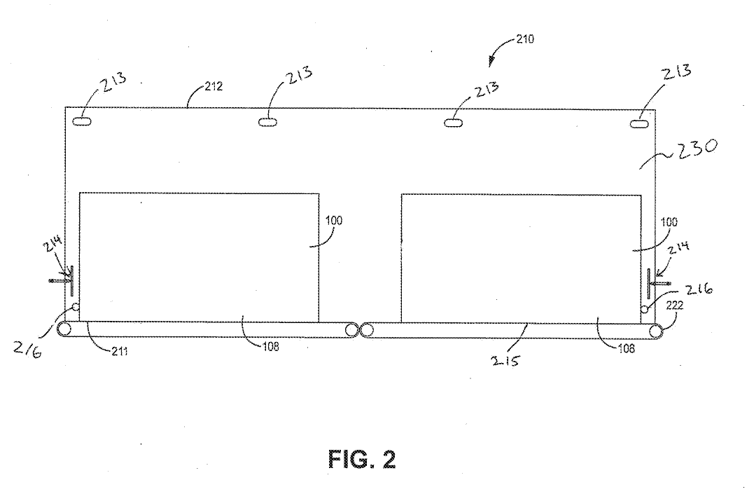

FIG. 2 schematically depicts some general aspects and features of a system 210 for assembling and filling an unsealed IGU assembly with an interpane gas during the manufacturing of a sealed IGU, such as the IGU depicted in FIG. 1. The system 210 includes a vacuum enclosure 212 that is configured to enclose one or more IGUs 100. In the depicted example the enclosure 212 encloses two IGUs 100. The system 210 includes a support structure 222 to support the IGUs 100 within the enclosure 212. In the example shown in FIG. 2, the support structure 222 includes a first conveyor belt 211 and a second conveyor belt 215.

FIG. 2 shows a point in the manufacturing process in which the IGUs 100 are unsealed IGU assemblies positioned within the enclosure. According to various embodiments, components of the IGU assemblies can enter the enclosure in a variety of ways including, for example, positioning by hand. In some cases the loading of components into the vacuum enclosure 212 can include conveying sheets of glass material and IGU subassemblies into the chamber 212 in a linear manner along a linear conveyor system. As shown in FIG. 2, the conveyor system includes the first conveyor belt 211 and the second conveyor belt 215.

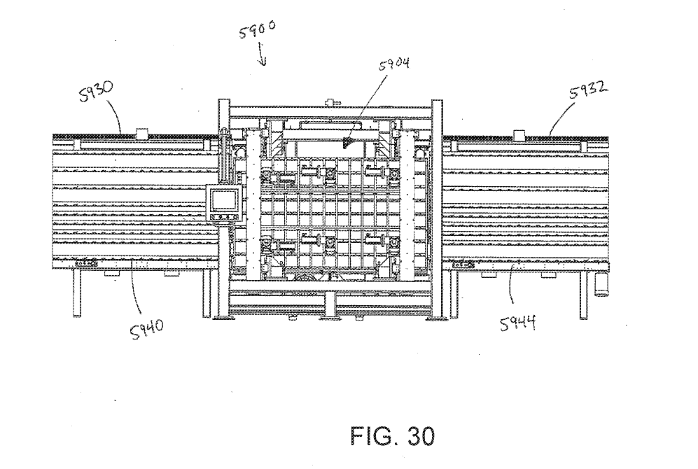

In some cases, the conveyor system further includes a pre-chamber support structure and/or a post-chamber support structure. FIG. 30 illustrates an example of a system 5900 having a pre-enclosure support structure 5930 and a post-enclosure support structure 5932. According to various embodiments, components for assembling into an IGU (unsealed or sealed) are transported into a vacuum chamber 5904 from a staging position on the pre-chamber support structure 5930 using a pre-enclosure conveyor 5940. Conveyors within the enclosure 5904, such as the conveyors 211, 215 in FIG. 2, move the components to desired locations within the enclosure 5904. In some cases, a conveyor 5944 that is part of a post-vacuum chamber support structure and staging area 5932 receives the assembled IGUs from the interior support conveyors and moves the assembled IGUs away from the vacuum enclosure for further manufacturing as needed.

As will be described in further detail herein, components can be assembled into an IGU assembly within the vacuum enclosure 212 according to various embodiments. Returning to FIG. 2, in some cases the system 210 includes an assembly plate system (not shown in FIG. 2) that is used to assemble components into an unsealed IGU assembly. In some embodiments, a first sheet of glass material is supported by support structure within the vacuum enclosure 212, such as conveyors 211, 215. The assembly plate system includes an assembly plate and an actuating system that are configured to move the first sheet away from the support structure while remaining within the vacuum enclosure 212. The support structure 211, 215 is configured to support an IGU subassembly after the first sheet is moved away by the assembly plate. The assembly plate is further configured to position the first sheet next to the IGU subassembly as part of forming an unsealed IGU assembly. In some cases the assembly plate includes and/or acts as a vacuum platen that holds the first sheet of glass material with a low pressure or vacuum force during movement away and toward the support structure.

Once the IGUs are assembled, the IGUs 100 can be evacuated and filled with one or more interpane gases within the enclosure 212. An unsealed IGU assembly (also referred to as unsealed IGU) defines an IGU passage for fluid communication between an interpane space 108 and an environment external to the IGU. Examples of environments external to the IGU, include the environment immediately surrounding the IGU, an interior of a vacuum enclosure, or a first gas supply tank.

There are several options for defining the one or more fluid communication passages to the interpane space 108 in an unsealed IGU assembly. For example, the unsealed IGU assembly can be a partially assembled IGU that is unsealed along at least a portion of the spacer frame and at least one of the sheets, but sealed along the remaining portion of the spacer frame. An IGU passage to the interpane space of the partially assembled IGU is defined at the unsealed edge portion in these examples. In another example of an unsealed IGU assembly, an IGU passage to the interpane space is defined through an opening or hole in the spacer frame, where the sheets are both sealed to the spacer frame along a perimeter of the spacer frame. In some cases the IGU passage can be an opening or hole in the first or second sheet. In yet another example, the unsealed IGU assembly is a wedge-sealed IGU where a filling block is positioned between the glass sheets outside of a perimeter of the spacer frame.

As shown in FIG. 2, both the enclosure 212 and the unsealed IGUs 100 can be filled with ambient air from the atmosphere in which the system 210 is located, such as a manufacturing facility. The enclosure 212 can then be sealed, such as to prevent the unintended flow of gases from outside the enclosure 212 to the inside, or from inside the enclosure 212 to outside. The system 210 further includes a vacuum source configured to evacuate a large part of the existing gas or air from the interior of the enclosure 212. The vacuum source can further evacuate the existing gas from the interpane space 108 of the unsealed IGUs 100, because the unsealed IGUs are within the enclosure.

In the implementation shown in FIG. 2, the enclosure includes a vacuum source that includes openings 213. The number of vacuum openings 213 can vary depending on the size and volume of the enclosure needing evacuation. The vacuum openings 213 shown in FIG. 2 are positioned in a back plate 230 of the enclosure 212, near the top of the enclosure 212. The relative location of the vacuum openings 213 can be selected so that the vacuum openings 213 are located away from IGUs positioned in the enclosure 212. As an example, the vacuum openings 213 may not be located directly adjacent to (e.g., in front of or behind) the flat sheet surfaces of the IGUs. This arrangement can avoid pulling a vacuum directly on the sheets of the IGU.

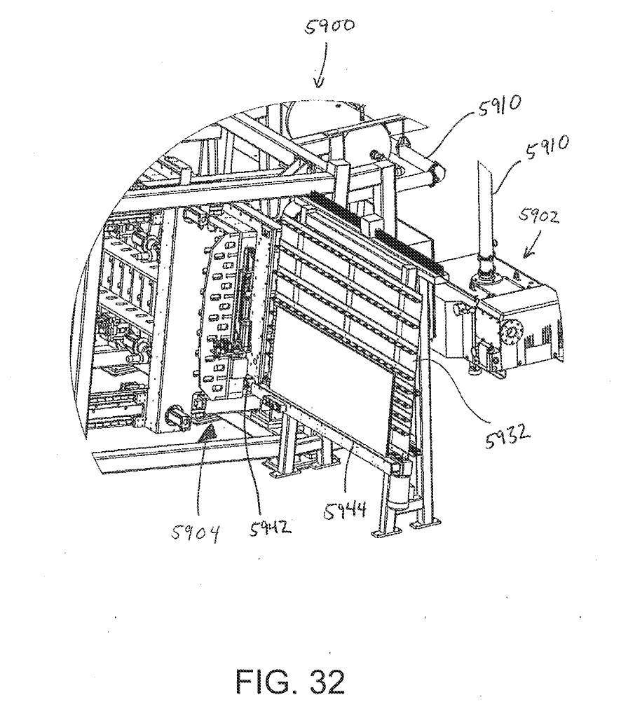

Although not pictured, the vacuum source can also include a vacuum generator (e.g., a vacuum pump) that is in fluid communication with the openings 213. FIG. 32 depicts one example of a vacuum generator 5902 that is part of an IGU gas filling system 5900 depicted in FIGS. 30-33. The system 5900 includes a vacuum enclosure 5904 configured to evacuate unsealed IGUs and then fill the interpane space of the IGUs with a gas. FIG. 32 includes a partial view of ducting 5910 that connects and provides selective fluid communication between the vacuum generator 5902 and vacuum openings (not shown) in the vacuum enclosure 5904.

Returning to FIG. 2, according to various embodiments, the system 210 includes a source or supply 214 of a first gas. In some cases the gas source includes a portion of a conveyor belt or other support structure which the unsealed IGU rests upon, such as through holes in a conveyor belt positioned below a bottom gap formed by an unsealed IGU assembly. In some cases, the gas supply includes a probe. As shown in FIG. 2, in some cases the source 214 can include a filling device. The supply or source 214 of first gas (e.g., including the filling device 214 shown in FIG. 2) is configured to introduce the first gas into the interpane space through an IGU passage. In various embodiments, the source 214 is configured to be positioned adjacent to the IGU passage, such that as gas is released from the source 214, the gas travels through the IGU passage and into the interpane space 108. In some cases the system 210 may also include a supply or source 216 of a second gas for filling the vacuum enclosure 212. In some cases the source 216 includes one or more openings in the back plate 230 of the enclosure 212. The supply 216 can include one, two, or more openings in the enclosure back plate 230. The supply 216 of a second gas can be configured to introduce the second gas into the enclosure 212. In various embodiments, the second gas is introduced to the volume within the enclosure 212 at a location that is external to the interpane space 108 and is not adjacent to the IGU passage.

The system 210 can further include a sealing device configured to seal the one or more unsealed IGUs after the first gas has been introduced into the interpane space 108. The sealing device can seal the one or more unsealed IGUs by closing or sealing the one or more IGU passages. As will be described further herein, according to some embodiments, one type of sealing device includes a press plate that is optionally part of an assembly plate. In this configuration, an adhesive can be applied to a spacer frame making up part of the IGU subassembly. The assembly and/or press plate presses the first sheet of glass material against the spacer frame to seal the first sheet against the spacer frame. In some cases the press plate may seal the first sheet together with the IGU subassembly, thus enclosing the interpane space of the IGU by filling the IGU passage. In some cases the press plate seals the first sheet and IGU subassembly together but the IGU passage is sealed in another manner. As an example, a press plate can seal a first sheet of glass material and an IGU subassembly together while a separate sealing device seals an IGU passage, such as a hole in the spacer frame, with a sealant, a rivet, or another suitable sealing mechanism or material.

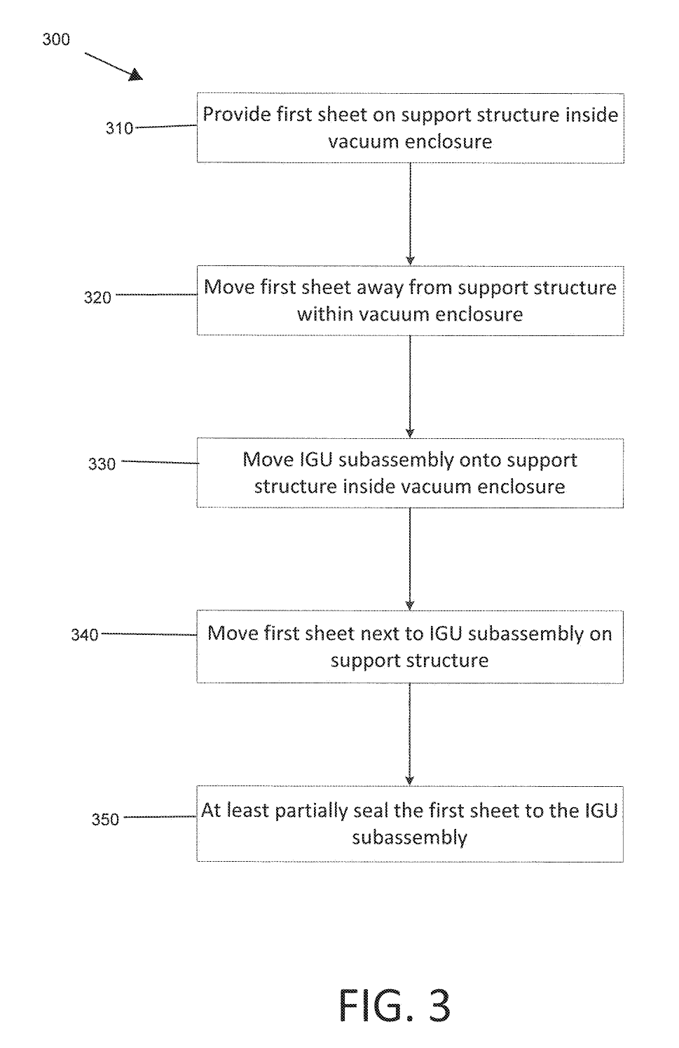

FIG. 3 is a flow chart depicting one possible method 300 for forming an unsealed IGU assembly according to various embodiments. The method 300 includes providing 310 a first sheet of a glass material on a support structure within a vacuum enclosure. As examples only, a first sheet may be moved onto the support structure in the interior of the vacuum enclosure by hand or optionally using a conveyor system, such as the conveyors previously discussed with respect to FIG. 2. In some cases the first sheet may be positioned on a pre-enclosure staging structure, such as a conveyor. The conveyor can then advance the first sheet into interior of the vacuum enclosure by transferring the first sheet to another conveyor within the vacuum chamber.

The method 300 further includes moving 320 the first sheet away from the support structure within the vacuum enclosure. The first sheet can be moved away from the support structure using a variety of methods. For example, the first sheet can be picked up and moved from the support structure using a robotic arm and/or other automated equipment. In some cases the first sheet is moved within the enclosure using an assembly plate driven by an actuating system. One implementation involves the assembly plate positively engaging the first sheet and then lifting the first sheet off the support structure. According to some embodiments, creating a vacuum between the assembly plate and the first sheet enables the assembly plate to engage and hold the first sheet.

The method 300 in FIG. 3 also comprising moving an IGU subassembly onto the support structure inside the vacuum enclosure. According to various embodiments, the IGU subassembly can be moved into the interior of the vacuum enclosure in the same manner as the first sheet of glass material was moved. For example, when the first sheet is moved into the vacuum enclosure using a pre-enclosure conveyor, the subassembly can be positioned on the pre-enclosure conveyor after the first sheet enters the chamber. Once the first sheet is moved away from the support structure, the IGU subassembly can be moved (e.g., linearly translated, conveyed, etc.) into the vacuum enclosure and onto the support structure.

After moving the IGU subassembly into the vacuum enclosure and positioning it on the support structure within the enclosure, the first sheet is moved 340 next to the IGU subassembly on the support structure. The first sheet can generally be moved next to the IGU subassembly using the same method and/or mechanism used to move the sheet away from the support structure. For example, an assembly plate that engages the first sheet and moves it away from the support structure can retain the first sheet during movement of the IGU subassembly and then place the first sheet next to the IGU subassembly on the support structure.

As will be discussed in greater detail herein, moving the first sheet of glass material next to the IGU subassembly and forming an unsealed IGU assembly can be implemented in various ways. For example, in some cases an assembly plate positions the first sheet next to the IGU subassembly in a leaning or tent-like configuration (also referred to herein as a “tent” configuration) on the support structure within the vacuum enclosure. The gap between the first sheet and the IGU subassembly provides an IGU passage that provides fluid communication between the IGU's interpane space and the surrounding environment

In some cases, an assembly plate places the first sheet next to the IGU subassembly and then presses the first sheet against the IGU subassembly to seal 350 at least part of the first sheet to at least part of the subassembly. In some cases an assembly plate presses the first sheet against the IGU subassembly to substantially seal the first sheet to the subassembly, while also leaving open an IGU passage that provides fluid communication into the IGU interpane space. As will be discussed, such implementations can involve a spacer frame or glass sheet with a hole or opening that provides the IGU passage. In some cases the IGU passage is provided by a filling block or optionally a wedge block that temporarily forms part of the seal between the first sheet and the IGU subassembly.

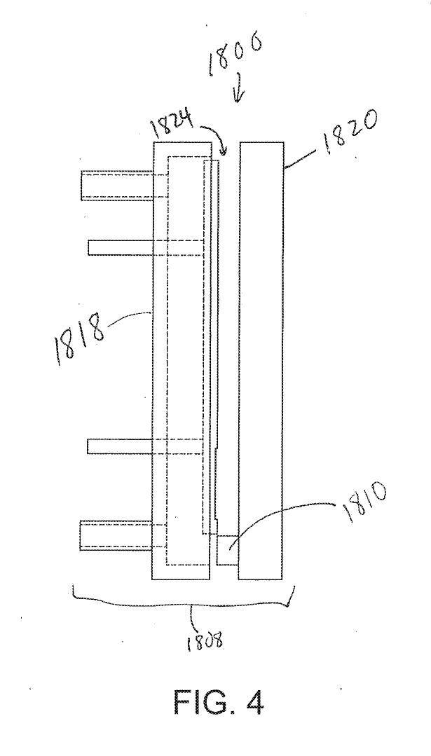

Turning now to FIGS. 4-10, various views related to methods and systems for assembling and optionally filling and/or sealing an unsealed IGU assembly are illustrated. The examples depicted and described can be useful for manufacturing sealed IGUs that are filled with an interpane gas.

FIG. 4 is a side schematic view of a system 1800 for manufacturing a sealed insulating glass unit (IGU). The system 1800 includes a vacuum enclosure 1808 and a support structure 1810 for supporting an IGU as it is assembled and filled with an interpane gas inside the vacuum enclosure. The vacuum enclosure 1808 is configured for receiving a first sheet 1830 of glass material upon the support structure 1810 as shown in FIG. 5. One possible manner of providing the first sheet 1830 on the support structure 1810 includes conveying the first sheet into the enclosure 1808. As discussed elsewhere herein, in some cases the support structure includes one or more conveyors located within the chamber. In some cases the support structure is located adjacent to a support plate or back plate provided by a portion of the vacuum chamber.

In the depicted implementation, the vacuum enclosure 1808 includes a first portion 1818 and a second portion 1820 that are configured to seal together around the first sheet 1830. According to various embodiments, the second portion 1820 is a fixed portion and the first portion 1818 is a movable portion. The support structure 1810 can be attached to the second portion 1820 and is configured to support the first sheet 1830. As an example, the vacuum enclosure illustrated in FIGS. 30-33 has a clamshell structure with a first portion and a second portion. In this case, one or more unsealed first sheets of glass material can be conveyed in a linear fashion from an initial assembly stage into an interior of the enclosure defined by the first and second portions. According to some embodiments, one enclosure portion is fixed and supports the first sheet with a support structure. The other enclosure portion then moves toward and seals with the first portion to create a sealed vacuum chamber or enclosure around the first sheet of glass material and/or other components.

Returning to FIG. 5, according to various embodiments, a sheet actuator moves the first sheet 1830 away from the support structure 1810 after it is positioned on the support structure 1810, in order to make room for an IGU subassembly. In some implementations, the sheet actuator includes a mechanical and/or robotic actuator that secures the first sheet and then moves it away from the support structure. As shown in FIG. 5, in some cases the sheet actuator includes an assembly plate 1852 that is movably mounted within the vacuum enclosure 1808. The assembly plate 1852 can be moved toward the first sheet 1830 to engage the first sheet and lift the sheet away from the support structure 1810.

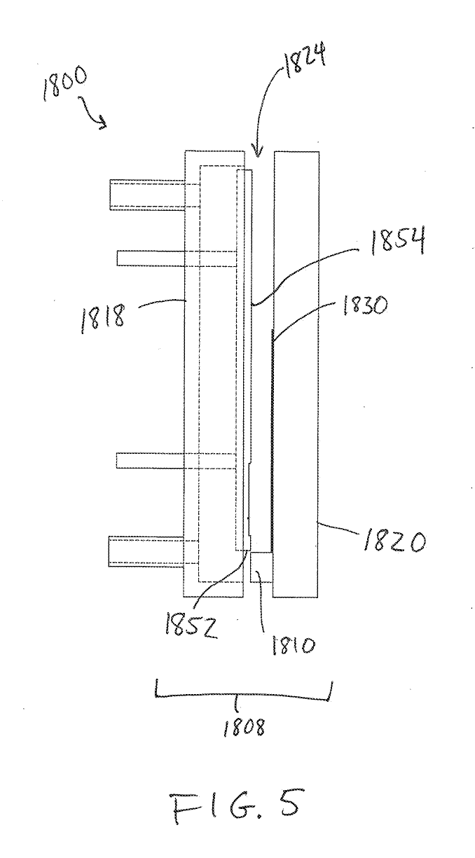

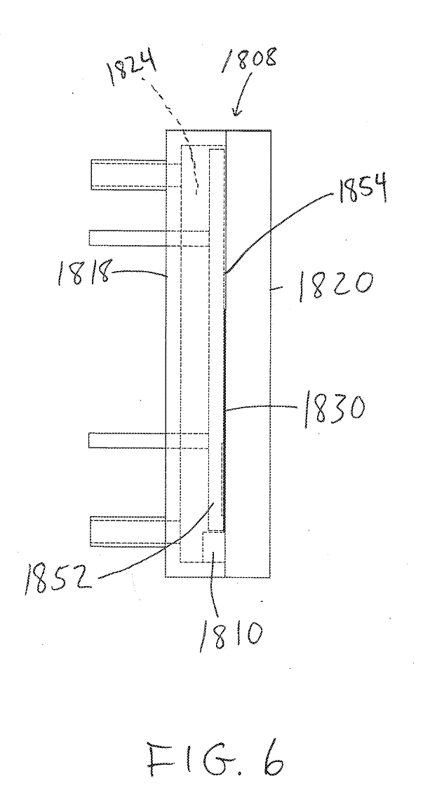

In some cases the assembly plate 1852 provides the functionality of a vacuum platen or optionally includes a separate vacuum platen. Turning to FIG. 6, when the assembly plate 1852 is positioned adjacent to the first sheet 1830 within the enclosure, a vacuum is created at the surface 1854 of the assembly plate 1852 between the assembly plate and the first sheet 1830. The low pressure from the force of the vacuum allows the assembly plate 1852 to positively engage the first sheet 1830, thus holding the first sheet against the assembly plate. According to various embodiments, the assembly plate then moves the first sheet away from the support structure 1810 as depicted in FIG. 7. In some cases, the assembly plate 1852 may initially lift the first sheet 1830 slightly above the support structure 1810 before moving the first sheet away from the support structure.

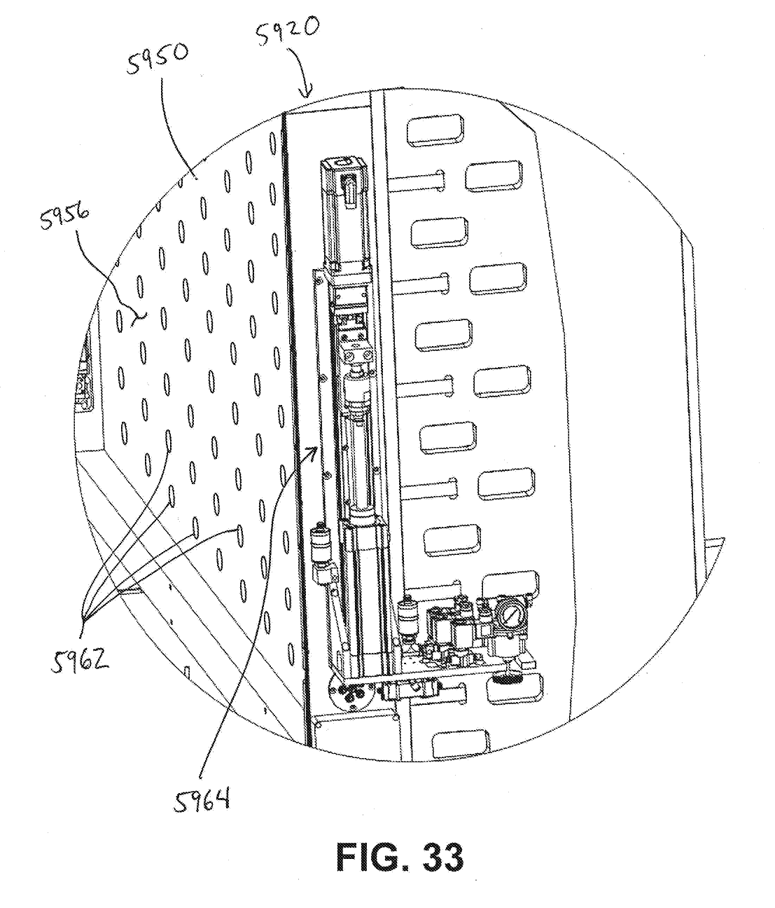

According to various embodiments, to create a vacuum at the surface 1854 of the assembly plate 1852, or with a separate vacuum platen, the assembly plate and/or the vacuum platen includes multiple openings in the surface 1854 of the plate that are in selective fluid communication with a vacuum source. As an example, FIGS. 30-33 depict a vacuum enclosure 5904 that includes a movable first portion 5920 and a fixed second portion 5922. As shown in FIG. 33, the movable first portion 5920 includes an assembly plate 5950 that is optionally configured as a press plate. In addition, the assembly plate 5950 includes openings 5962 for generating a vacuum at the surface 5956 of the plate. The openings 5962 are in selective fluid communication with a vacuum source.

In some cases, the vacuum source is the same vacuum source that is used for evacuating the interior of the sealed vacuum enclosure. In some cases, a separate vacuum source can be used for generating the vacuum with the assembly plate 5950. As shown in FIG. 32, the system 5900 includes a vacuum generator 5902 that is in selective fluid communication with the system 5900 through ducting 5910. According to some embodiments, the ducting 5910 selectively delivers the vacuum force from the generator 5902, e.g., via controllable switches and/or valves, to 1) the vacuum enclosure 5904 for evacuating the interior of the enclosure, 2) a filling device probe for evacuating an interior of an unsealed IGU through the filling device, and/or 3) the multiple openings 5962 in the face of the assembly plate 5950 depicted in FIG. 33.

According to some embodiments, the openings 5962 in the assembly plate 5950 can also be in selective fluid communication with a gas supply apparatus 5964. In such cases, the assembly plate and openings can also be used to deliver a gas into the interior of the vacuum enclosure 5904, after being used to evacuate the interior of the enclosure 5904 shown in FIGS. 30-33.

According to some embodiments, the assembly plate can include multiple openings for separately evacuating the enclosure and separately delivering a gas into the enclosure. In addition, in some cases the assembly plate 5950 in FIG. 33, as well as the assembly plate 1852 in FIG. 7, can apply the vacuum force to the first sheet 1830. In some cases the assembly plate acts as a press plate, and thus pushes or presses the first sheet 1830 to seal it against an IGU subassembly as will be discussed. In some cases, the assembly plate 1852 is configured to apply the vacuum to the first sheet 1830 and to press the first sheet 1830. This configuration can be useful in that the assembly plate 1852 can function as both a vacuum platen and a press plate.

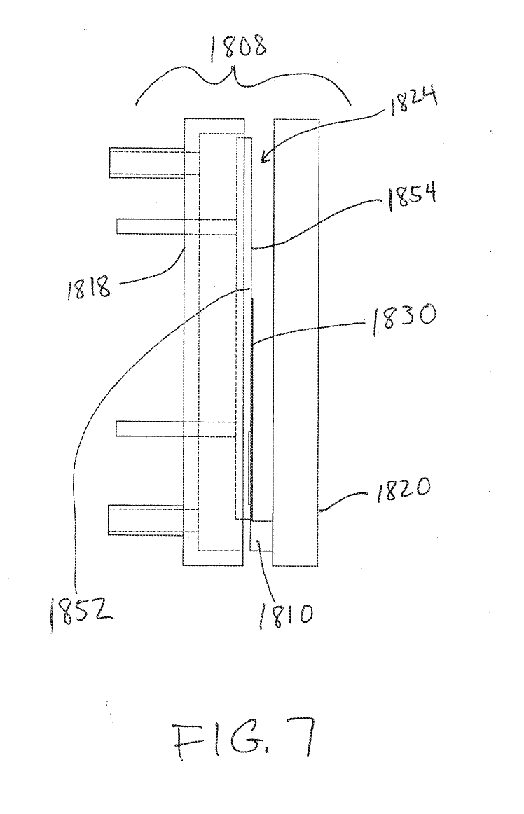

As shown in FIGS. 4-10, the assembly plate 1852 can be carried by the movable first portion 1818 of the vacuum chamber according to some embodiments. Although not shown in FIGS. 4-10, an actuating system, such as a system of drive motors and controls, is coupled to the assembly plate 1852 for moving the plate. In some cases the assembly plate 1852 can be carried by the fixed second portion 1820 of the vacuum chamber. According to various embodiments in which the assembly plate is carried by the movable portion, moving the first sheet 1830 away from the support structure 1810 involves retracting the first sheet 1830 toward the movable portion 1818 of the vacuum enclosure. In this type of implementation, the assembly plate first positively engages the first sheet 1830 and optionally lifts the sheet off of the support structure 1810 using, e.g., a vacuum. The assembly plate 1852 then moves away from the support structure 1810 toward the movable portion 1818 of the enclosure as shown in FIGS. 7 and 8.

Turning to FIG. 8, moving the first sheet 1830 clears the support structure 1810, providing room for moving an IGU subassembly 1828 into the open vacuum chamber and onto the support structure 1810. As used herein, the term “IGU subassembly” refers to one, two, three, or more components of an IGU. According to various embodiments, the IGU subassembly 1828 includes a spacer frame 1832 attached or sealed to a second sheet of glass material 1834.

In some implementations, moving the IGU subassembly 1828 into the open vacuum enclosure includes conveying the combination of the spacer 1832 and sheet 1834 into an interior 1824 of the enclosure and positioning the subassembly 1828 on the support structure 1810 of the vacuum enclosure 1808. As shown in FIG. 8, in some cases the IGU subassembly 1828 is placed on the support structure 1820 with the second sheet 1834 of glass material adjacent to a back plate 1826 of the enclosure, with the spacer frame 1832 oriented out away from the back plate, facing the interior 1824 of the chamber.

As shown in FIG. 8 and other figures, the first sheet 1830 and the IGU subassembly 1828 are separately moved onto the support structure 1810 adjacent to the back plate 1826 of the enclosure. In the illustrated examples, the support structure 1810 is depicted as a having a horizontal top surface that forms a right angle with the back plate, which is vertically-oriented. It is also possible to use different support structures, conveyors, back plates, and the like that support the first sheet and IGU subassembly at different orientations.

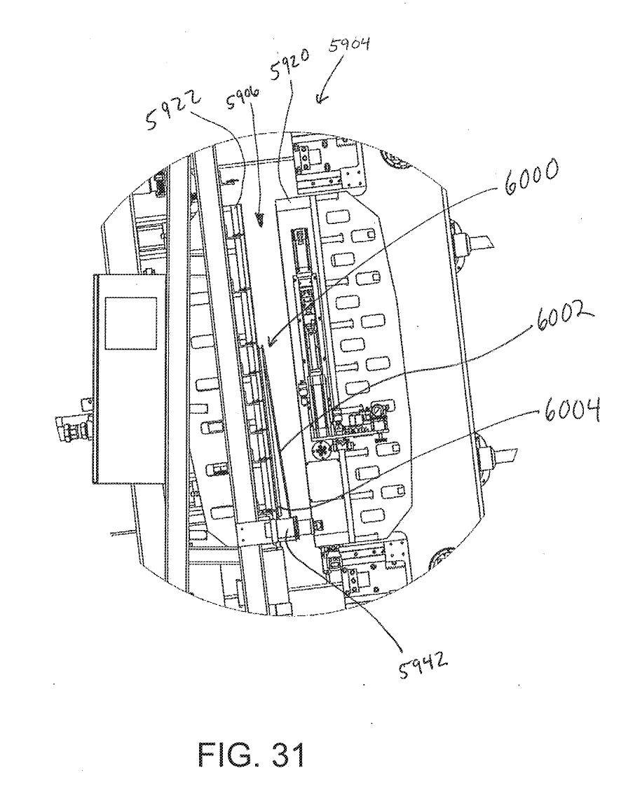

In some cases the support structure 1810 and the back plate 1826 are tilted or angled with respect to horizontal and/or vertical orientations. As an example, the enclosure 5904 shown in FIGS. 30-33 includes a fixed portion 5922 in the form of an angled back plate and an attached, movable support structure 5942 such as a conveyor. FIG. 31 illustrates an unsealed IGU assembly 6000 after assembly within the enclosure 5904. The unsealed IGU assembly 6000 includes a first sheet of glass material 6002 leaning against an IGU subassembly 6004 in a tented configuration. The IGU subassembly is formed from a spacer frame sealed against a second sheet of glass material.

According to various embodiments, the angle of the back plate is between about 5 degrees and about 10 degrees away from a vertical axis of the vacuum enclosure. The top surface of the support structure 5942 in this case forms a right angle with the back plate, but is angled with respect to a horizontal orientation due to the tilt of the back plate. In some cases the angle of the back plate is about 6 degrees, about 7 degrees, or about 6.5 degrees. Other suitable angles are also possible.

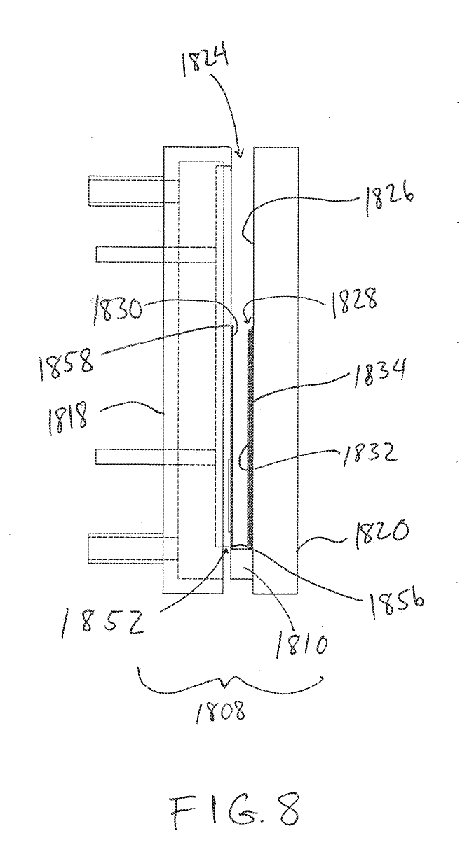

Referring to FIGS. 8 and 9, various embodiments include positioning the first sheet 1830, held by the assembly plate 1852, relative to the IGU subassembly 1828 located on the support structure 1810. In some cases the assembly plate 1852 moves the first sheet 1830 next to the IGU subassembly 1828 on the support structure 1810 as part of forming an unsealed IGU assembly 1814 within the interior 1824 of the vacuum enclosure.

According to various embodiments, such as the example depicted in FIG. 9, the unsealed IGU assembly 1814 is also a partially assembled IGU. In this example, the unsealed and partially assembled IGU has a tent configuration in which the first sheet 1830 is leaning against the IGU subassembly 1828. A gap 1836 formed between the IGU subassembly 1828 and the first sheet 1830 provides an IGU passage into an interpane space between the first sheet 1830 and the second sheet 1834 that forms part of the IGU subassembly.

In some cases the assembly plate 1852 moves a calculated distance relative to the enclosure back plate 1826 as part of forming a desired gap 1836 at the bottom of the unsealed, tent-configured IGU assembly 1814. According to various embodiments, the assembly plate 1852 positions a bottom edge 1856 of the first sheet on or nearly on (e.g., slightly above) the support structure 1810 at the desired distance from at least one of the IGU subassembly 1828 and the back plate 1826 of the enclosure. In various embodiments, the gap extends along the entire length of the IGU. In some embodiments, the gap 1826 has a width from the edge of the spacer frame 1832 to the first sheet 1830 of at least 0.05 inches and not more than 1.0 inch.

After the assembly plate 1852 moves the first sheet 1830 to the desired position, the assembly plate 1852 releases the first sheet 1830. As an example, the vacuum created between the assembly plate 1852 and the first sheet 1830 can be removed. Releasing the first sheet 1830 from the assembly plate 1852 can allow a top edge 1858 of the first sheet to move toward or lean against the spacer frame 1832 while the bottom edge 1856 of the first sheet 1830 remains at or near the calculated distance away from the spacer frame 1832. According to various embodiments, the support structure 1810 and enclosure back plate 1826 supporting the IGU subassembly and first sheet are angled back with respect to a vertical axis of the vacuum enclosure. In some cases the assembly plate 1852 has an angled orientation that matches the angle of the back plate. The angle of the assembly plate 1852 in these cases enables the first sheet 1830 to easily fall against the IGU subassembly 1828 once released by the assembly plate.

According to some embodiments, a sealant or other adhesive is applied to the spacer frame 1828 before it enters the chamber. The sealant can thus attach or seal the top edge 1858 of the first sheet 1830 to the spacer frame 1832 when the first sheet falls against the IGU subassembly in various embodiments.

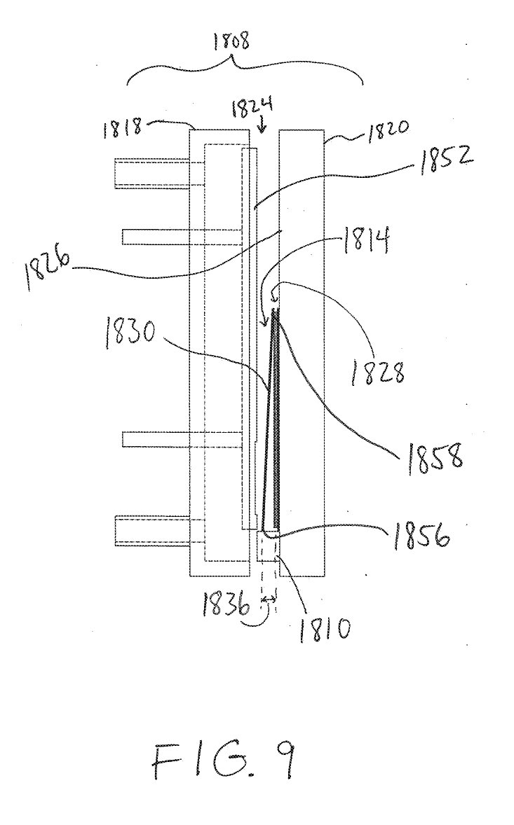

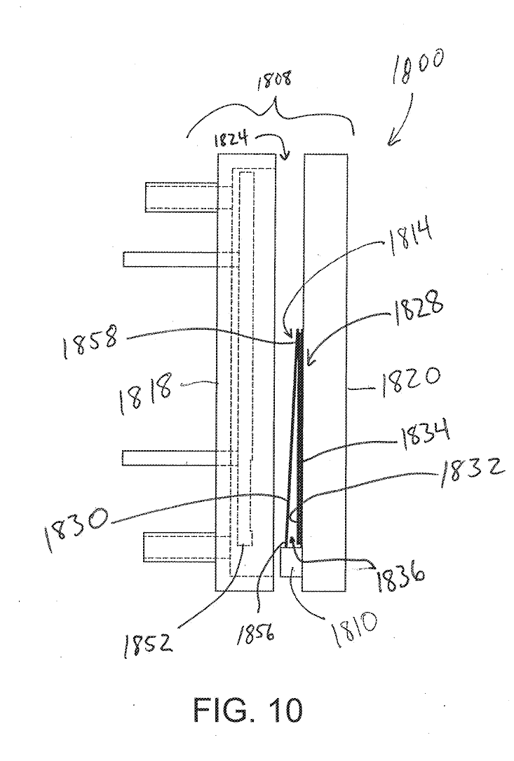

Turning to FIG. 10, in some cases the assembly plate 1852 moves away from the support structure 1810 after positioning the first sheet 1830 next to the IGU subassembly 1828. Thus, an unsealed, partially assembled IGU assembly 1814 is formed on the support structure 1810 within the interior 1824 of the vacuum enclosure according to various embodiments.

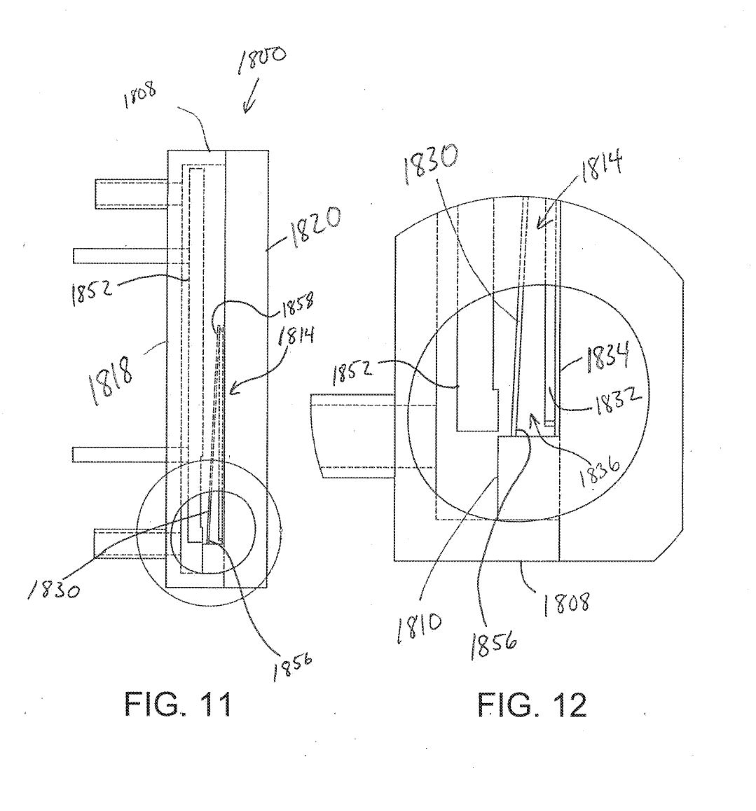

According to various embodiments, the vacuum enclosure 1808 is sealed about the first sheet 1830 and the IGU subassembly 1828 as shown in FIGS. 11 and 12. In some cases the first and second portions 1818, 1820 of the enclosure can be sealed at any one of multiple points in time before, during, or after assembling the unsealed IGU assembly 1814 within the enclosure 1808. In some implementations the enclosure 1808 is closed and sealed before evacuating and filling the unsealed IGU assembly 1814 with an interpane gas. Accordingly, in these cases the first and second portions of the enclosure could be closed and sealed at any time after the first sheet 1830 and the IGU subassembly 1828 are received within the enclosure. In some cases the enclosure 1808 is closed and sealed after forming the unsealed IGU assembly 1814. In some implementations the enclosure is closed and sealed after some steps in forming the unsealed IGU assembly but before finishing all the steps in forming the unsealed IGU assembly.

According to various embodiments, air is evacuated from the vacuum enclosure after sealing the vacuum enclosure about the first sheet and the IGU subassembly. The formation of the unsealed IGU assembly with an IGU passage enables the unsealed IGU assembly to be evacuated at the same time as the vacuum enclosure. For example, a vacuum can be pulled on the closed and sealed enclosure 1808 shown in FIGS. 11-12 while the unsealed IGU assembly 1814 remains supported on the support structure 1810. Pulling a vacuum on the enclosure exhausts gas through the gap or passage 1836 between the spacer frame 1832 and the first sheet 1830.

According to various embodiments, air may be evacuated from the unsealed IGU assembly simultaneously with air being evacuated from the chamber. In various embodiments, the unsealed IGU assembly can also be evacuated before or after the vacuum chamber.

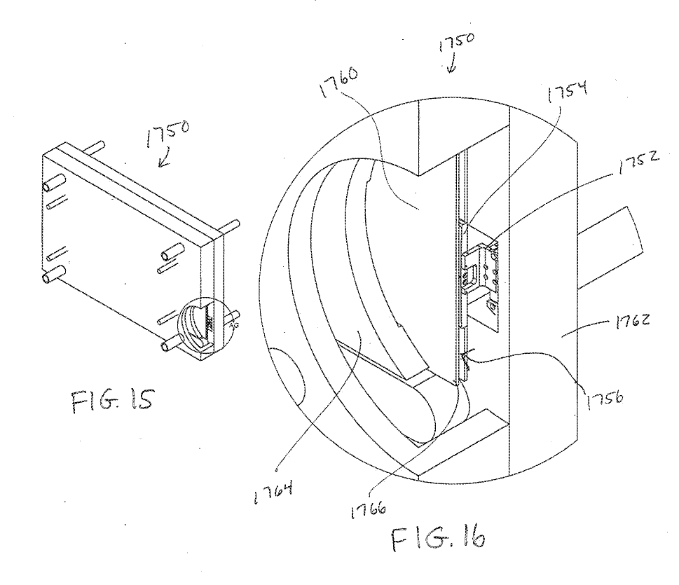

According to various embodiments, a gas can be introduced into the interpane space after formation of an unsealed IGU assembly. FIGS. 15-16 are cut away perspective views illustrating a manner of filling an unsealed IGU assembly with an interpane gas as taught in U.S. Publ. No. 2017/0299121. The figures depict a vacuum enclosure 1750 showing an actuator 1752 with a connected filling device 1754 positioned within a channel 1756 of an unsealed IGU assembly 1760. In this embodiment the actuator and filling device are mounted to a back plate 1762 or fixed portion of the vacuum enclosure 1750. A press plate 1764 has already pressed an outer sheet 1766 against the IGU's spacer frame and the filling device 1754 to form a wedge-sealed IGU. A gas supply or source (not shown) connected to the filling device would be used in conjunction with the filling device to fill the interpane space of the IGU with a desired gas. Afterward, the actuator 1752 would pull the filling device out from the IGU's channel 1756 so that the outer sheet 1766 could be completely sealed to the spacer frame, creating a sealed IGU, according to various embodiments.

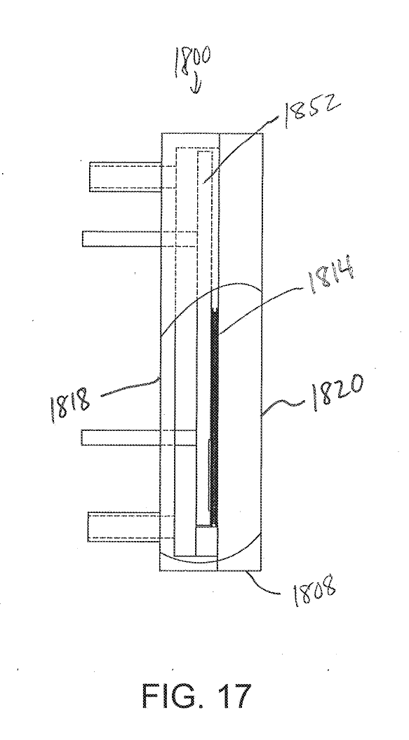

FIG. 17 is a side view of the enclosure 1808 of FIG. 4 depicting the unsealed IGU assembly 1814 inside the enclosure 1808, according to various embodiments. The system 1800 is shown with the first and second portions of the vacuum enclosure 1808 closed and sealed. In some cases the unsealed IGU assembly 1814 is no longer partially sealed. As illustrated, the assembly plate 1852 has pressed the first sheet, the spacer frame, and the second sheet against the second portion 1820 of the enclosure, thus sealing off the interpane space of the IGU according to various embodiments. In some cases a filling device (not shown) may still be inserted into the IGU assembly, and thus a wedge passage and a filing device passage extending through filling device may still be present. Accordingly, a source or supply of gas that includes the filling device can be used to introduce the gas through the passages into the interpane space.

After introducing the gas into the IGU interpane space, the IGU passage is closed to seal the interpane space. According to various embodiments, the IGU passage is sealed before the IGU exits the chamber. According to various embodiments, the IGU passage is sealed after the IGU exits the chamber.

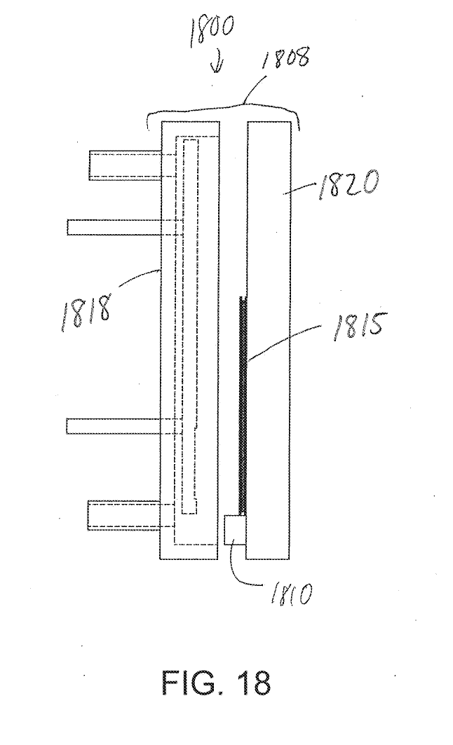

FIG. 18 is a side view of the enclosure 1808 with the assembling and filling process complete. The enclosure 1808 is in an open or unsealed configuration, with the first and second portions 1818, 1820 moved apart. In addition, the assembly plate 1852 has been moved away from the now-filled IGU 1815 that is supported by the support structure 1810. The IGU 1815 can exit the enclosure 1808, e.g., by conveyor or another means.

Related U.S. Publ. No. 2017/0299121, filed Jul. 1, 2017, describes examples of evacuating a vacuum chamber, introducing a gas into an IGU interpane space, and closing and sealing an IGU passage of the unsealed IGU assembly, all of which may apply and supplement the teachings herein. The content of U.S. Publ. No. 2017/0299121 is incorporated herein by reference in its entirety.

In the example shown and described above with respect to FIGS. 9-10 and FIGS. 11-12, the unsealed IGU assembly 1814 has a first sheet 1830 with a bottom edge 1856 that is spaced apart from the bottom of the IGU subassembly 1828. The spacing creates a gap or opening 1836 along the bottom edges and, to a decreasing extent, along the side edges, between the first sheet 1830 and the spacer frame/second sheet subassembly 1828. According to some embodiments, the gap or opening 1836 is one possible type of IGU passage that provides fluid communication between an exterior of the unsealed IGU assembly 1814 and the interpane space of the unsealed IGU assembly. As discussed above, in various embodiments, the unsealed IGU assembly can be evacuated and filled with an interpane gas, and then sealed completely to retain the interpane gas within the sealed IGU.

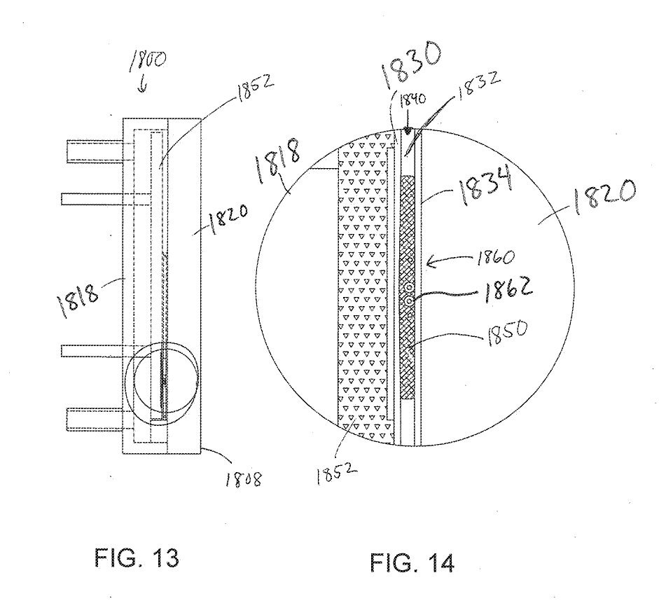

In various embodiments an unsealed IGU assembly is formed using a filling device. As shown in FIGS. 13-14, a system 1800 for manufacturing a sealed IGU includes a filling device 1850 that is positioned between first and second sheets 1830, 1834. The filling device 1850 provides an IGU passage 1862 for evacuating the unsealed IGU assembly and/or for filling the unsealed IGU assembly with an interpane gas or another gas. In some cases the passage 1862 leading through the filling device is in fluid communication with a hole or other opening in the spacer frame or sheets that leads to the interpane space within the assembly. In various embodiments, the passage 1862 is in fluid communication with another passage created between the first sheet 1830 and the spacer frame 1832 by the filling device 1850. The passage extending between the first sheet and the spacer frame provides fluid communication between the filling passage and the interpane space.

As shown in FIGS. 13-14, the filling device 1850 is located within a channel 1840 defined on three sides by the first and second sheets and the spacer frame. Accordingly, in this example the filling device 1850 is located outside of the external perimeter of the spacer frame 1832. Examples and other details about filling devices can be found in U.S. Publ. No. 2017/0299121, the relevant portion of which are herein incorporated by reference.

As shown in FIGS. 13-14, according to some embodiments, an assembly plate 1852 functions as a press plate that can press the first and the second sheets 1830, 1834 together about the filling device 1850. In some cases this kind of assembly/press plate is used to press together the tented, partially assembled IGU 1814 described with respect to FIGS. 9-11. With respect to FIGS. 9-11, in some cases, a filling device is inserted between the IGU subassembly 1828 and the first sheet 1830 leaning against the subassembly. The assembly plate 1852 presses the components together to make the unsealed IGU assembly 1860 illustrated in FIGS. 13-14.

According to various embodiments, one type of filling device that can be used to form an unsealed IGU assembly is a wedge filling block. The wedge filling block is placed in the same manner as the filling device 1850 illustrated in FIGS. 13-14, and includes a fluid passage extending through the block. The wedge filling block lifts a portion of the first sheet slightly above and edge of the spacer frame to create a wedge passage between the first sheet and the spacer frame. The wedge passage is in fluid communication with the passage extending through the wedge filling block. U.S. Publ. No. 2017/0299121 describes additional details and features of possible implementations for a wedge filling block, the relevant portion of which are herein incorporated by reference.

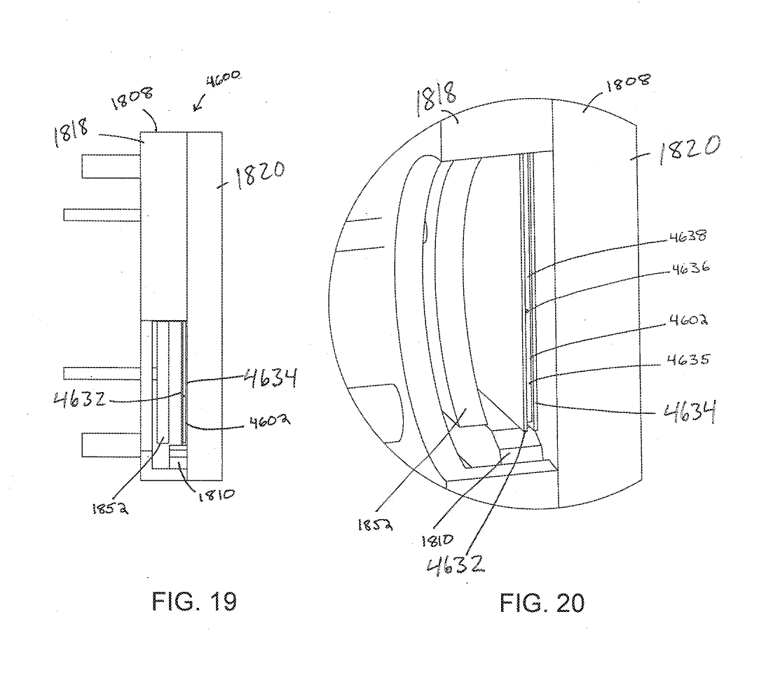

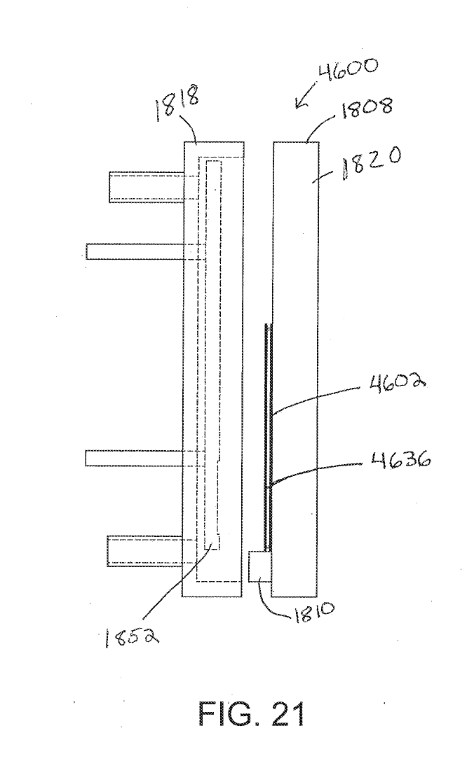

FIGS. 19-21 illustrate assembling an IGU using a system 4600 including a vacuum enclosure 1808, according to various embodiments where an unsealed IGU defines an IGU passage through a hole in a spacer frame. U.S. Publ. No. 2017/0299121 describes additional details and features of possible implementations of the system 4600, the relevant portion of which are herein incorporated by reference.

At an early stage of a filling process, an open, empty vacuum enclosure 1808 is provided, including a first portion 1818, second portion 1820 and support structure 1810. The vacuum enclosure 1808 shown in FIGS. 19-21 is similar to the vacuum enclosure 1808 illustrated in FIG. 4 and other FIGS, and the description and its alternatives provided herein also apply to the vacuum enclosure 1808 of FIGS. 19-21.

At an early stage of the filling process, a vacuum enclosure 1808 that is open and empty, as shown in FIG. 4, can be used to form an unsealed IGU 4602 in the vacuum enclosure interior and can close around the unsealed IGU to form a sealed interior, as shown in FIGS. 19 and 20. FIG. 19 is a side view of the system 4600 with a part of the vacuum enclosure first portion 1818 cut away. FIG. 20 is a side perspective close-up view, also with part of the first portion 1818 cut away. The unsealed IGU 4602 is positioned on the support structure 1810 within the closed vacuum enclosure in FIGS. 19-20. In the example of the FIGS, the unsealed IGU 4602 includes a first sheet 4632, a second sheet 4634, and a spacer frame 4635 positioned between the first and second sheets. The unsealed IGU defines an IGU passage to the interpane space of the IGU, through a hole 4636 in the spacer frame 4635, shown in FIG. 19. When the hole 4636 is referred to in the description of the FIGS., it is understood that the term IGU passage can be substituted for hole. The IGU assembly 4602 defines an open channel 4638 formed between the first and second sheets and next to spacer frame 4635.

There are several different ways of providing the unsealed IGU 4602 on the support structure within the vacuum enclosure 1808 as shown in FIGS. 19 and 20. The hole 4636 can be created in a spacer structure before or after it is formed into a spacer frame. The hole could be created before or after the spacer frame is attached to the first sheet. The hole could be created before or after the first and second sheets are sealed to the spacer frame. For each of these different points in the process of forming the unsealed IGU assembly, the hole could be created within the vacuum enclosure, before the IGU subassembly enters the vacuum enclosure, before or after the vacuum enclosure is closed, before or after the unsealed IGU assembly is formed, and before or after the vacuum enclosure is evacuated. The hole 4636 could be created with a drill, saw, knife, press or other implement.

In some examples, the hole 4636 has a diameter of at least about 0.040 inch, at least about 0.060 inch, at most about 0.25 inch, at most about 0.50, ranging from 0.060 to 0.25 inch, or about 0.125 inch.

In one example, a partially assembled, tented IGU like shown in FIGS. 9-10 is formed in the vacuum chamber in the manner described above with respect to FIGS. 4-10, with a hole already provided in the spacer frame. The vacuum enclosure is closed around the partially assembled IGU. The vacuum enclosure is then evacuated. Because the partially assembled IGU defines an open bottom portion between the first and second sheets, the air in the interpane space is also evacuated. Then the press plate 1852 is actuated to press the first sheet 1830 against the spacer frame to form an unsealed IGU as shown in FIGS. 19-21.

In another example, the interpane space is evacuated through the hole in the spacer frame 4635 after the first sheet is sealed to the spacer frame. In one embodiment, to reduce the risk of the IGU exploding due to a pressure differential with the vacuum enclosure, the vacuum enclosure and the interpane space are be evacuated substantially simultaneously, so that the pressures in each are within 1 pound per square inch.

In the embodiments illustrated in FIGS. 19-21, while the unsealed IGU is within the vacuum chamber, the interpane space is filled with a first gas, while a gas is also introduced substantially simultaneously into the vacuum enclosure's interior. In one embodiment described in detail in U.S. Publ. No. 2017/0299121, a first gas is introduced to the interpane space while a second gas is introduced to the vacuum chamber. In another embodiment, the same gas is introduced into both spaces. U.S. Publ. No. 2017/0299121 describes additional details and features, the relevant portion of which are herein incorporated by reference.

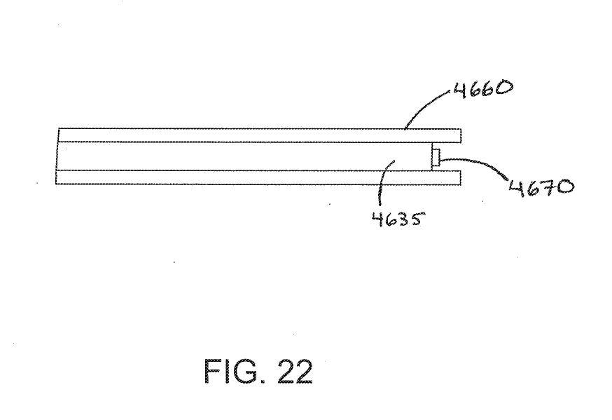

FIG. 22 is a top view of a sealed IGU 4660, including a first sheet, a second sheet, a spacer frame, and a 670 plugging a hole in the spacer frame. As shown in FIG. 22, in one embodiment, the hole in the spacer frame is sealed by providing a rivet in the hole. In one embodiment, a rim of the rivet is provided with a sealant material to seal to the surrounding surface of the spacer frame. In another embodiment, the hole is sealed by providing a sealant material in the IGU passage that blocks fluid communication between the interpane space and the surrounding environment. Examples of sealant materials include polyisobutylene (PIB), butyl, curable PIB, hot melt silicon, acrylic adhesive, acrylic sealant, and other Dual Seal Equivalent (DSE) type materials. Other examples include other materials. In another embodiment, the hole in the spacer frame is sealed by covering the hole with tape or a patch.

In one example, a filling device defines a sealing conduit that is configured to provide a structure or material to seal the IGU passage, such as sealant material, a patch, a rivet, or a piece of tape. After filling the interpane space, the filling device can automatically move so that the sealing conduit is in in fluid communication with the IGU passage, and then provide the sealing structure or material to seal the IGU passage. In another example, the filling device is moved away from the IGU passage after filling the interpane space, and a seal head including a sealing conduit is moved into communication with the IGU passage to provide a sealing structure or material. In one embodiment, the sealing conduit is a rigid conduit for moving a rivet into the IGU passage.

According to various embodiments, a first sheet is provided on a support structure inside a vacuum enclosure, and then moved away (while still within the vacuum enclosure) to make room for receiving an IGU subassembly on the support structure. As described elsewhere herein, an IGU subassembly for mating with a first sheet generally includes at least a second sheet of glass and a spacer frame sealed to the second sheet of glass. In examples previously described, an IGU subassembly for a double pane IGU includes at least a second sheet of glass and a spacer frame sealed to the second sheet of glass.

According to various embodiments, an IGU subassembly for a triple pane IGU includes at least a second sheet of glass, an intermediate pane of a transparent or translucent material defining an opening, and at least one additional spacer frame sealed to the second sheet of glass and sealed to the intermediate pane. Some triple pane IGUs include a single spacer frame, and some include two spacer frames. The concepts described herein can apply to a double pane IGU assembly, a triple pane IGU assembly with a single spacer frame, and to a triple pane IGU assembly with two spacer frames. Where the term “the spacer frame” is used in this description, it can generally be replaced with “the at least one spacer frame” to apply to the context of a triple pane IGU with two spacer frames. U.S. Publ. No. 2017/0299121 provides additional details and teaching about assembling and filling a triple pane IGU, the relevant portion of which is herein incorporated by reference.

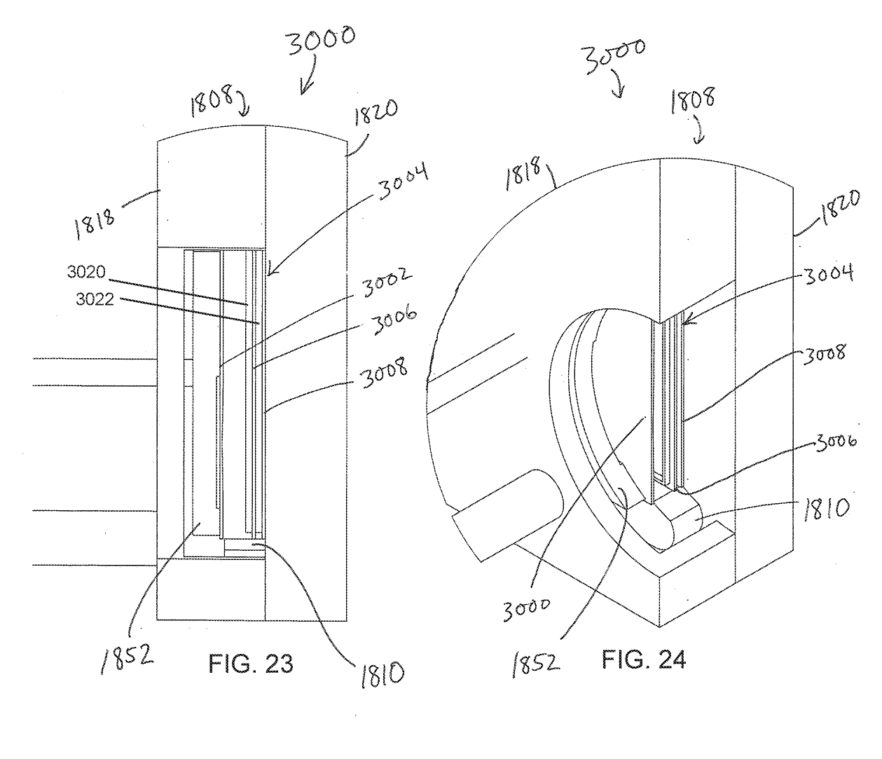

FIGS. 23-29 show steps in assembling a triple pane IGU assembly according to various embodiments. This particular example for assembling a triple pane IGU assembly is similar to the process of assembling the double pane IGU assembly illustrated in FIGS. 4-12, with the triple pane stage in FIG. 23 corresponding to the double pane stage in FIG. 8.

At an early stage of the illustrated triple pane assembly process, an open, empty vacuum enclosure 1808 is provided, as shown in FIG. 4, including the first portion 1818, second portion 1820 and support structure 1810. The vacuum enclosure 1808 shown in FIGS. 23-29 is also similar to the vacuum enclosure 1808 illustrated in FIG. 4 and other FIGS and the description and its alternatives provided herein also apply to the vacuum enclosure 1808 of FIGS. 23-29.

As with the examples described with respect to FIGS. 4-12, the vacuum enclosure 1808 in FIGS. 23-24 begins open and empty and can receive a first sheet 3002 on the support structure 1810 within the interior of the vacuum enclosure. As shown in FIGS. 23-24, the assembly plate 1852 has already moved the first sheet 3002 away from the support structure 1810, similar to movement of the first sheet 1830 from FIG. 5 to FIG. 6 to FIG. 7. An IGU subassembly 3004 has been moved onto the support structure 1810 in FIGS. 23-24. In this example, the IGU subassembly 3004 is formed from a spacer frame 3020 sealed to a second sheet 3006, a third sheet 3008, and a second spacer frame 3022 sealed between the second sheet and the third sheet.

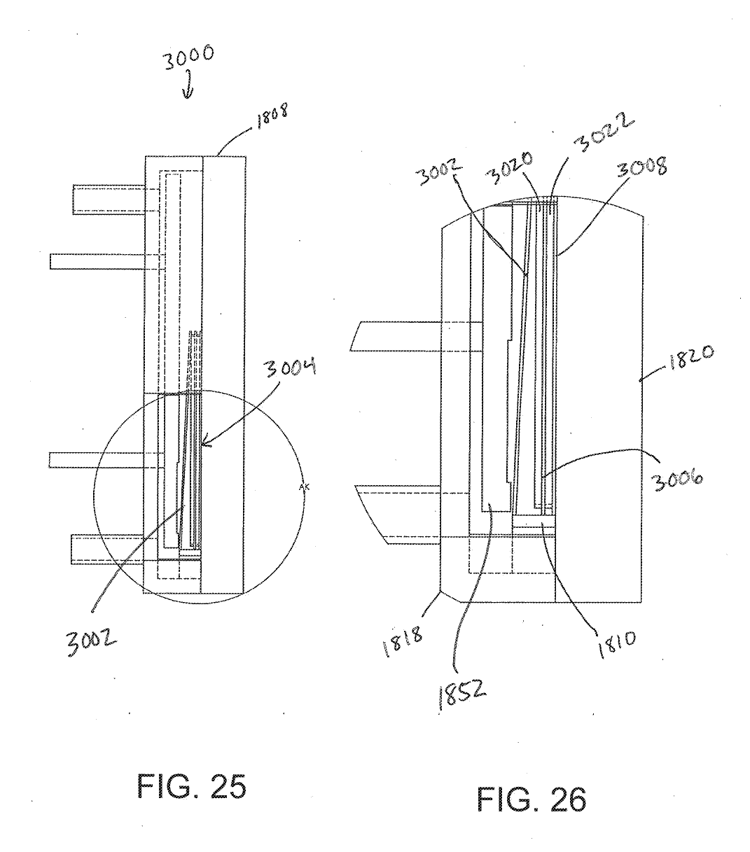

In the example described with respect to FIGS. 8-10, the assembly plate 1852 moves the first sheet 1830 next to the IGU subassembly 1828 on the support structure 1810 as part of forming an unsealed IGU assembly having a tent configuration in which the first sheet 1830 is leaning against the IGU subassembly 1828. According to the embodiment depicted in FIGS. 23-26, the assembly plate 1852 moves the first sheet 3002 next to the IGU subassembly 3004 on the support structure 1810 as part of forming the tented unsealed IGU assembly depicted in FIGS. 25-26, in which the first sheet 3002 is leaning against the IGU subassembly 3004, specifically the first spacer 3020.

In accordance with various embodiments, the methods and mechanisms for assembling, evacuating, filling, and/or sealing a triple pane IGU—whether partially assembled and unsealed, assembled and unsealed with an IGU passage, or other configurations—are analogous to (e.g., similar to or the same as) the methods and mechanisms described herein with respect to other embodiments. As an example, evacuating the partially assembled and unsealed triple pane IGU assembly can be similar to evacuating the partially assembled, unsealed IGU assembly 1814 depicted in and described with respect to FIGS. 4-22, with the modifications that the intermediate sheet 3020 takes the place of the second sheet 1834 of IGU 1814, and the triple pane IGU includes an additional spacer frame 3022 and sheet 3008 when compared to IGU 1814.

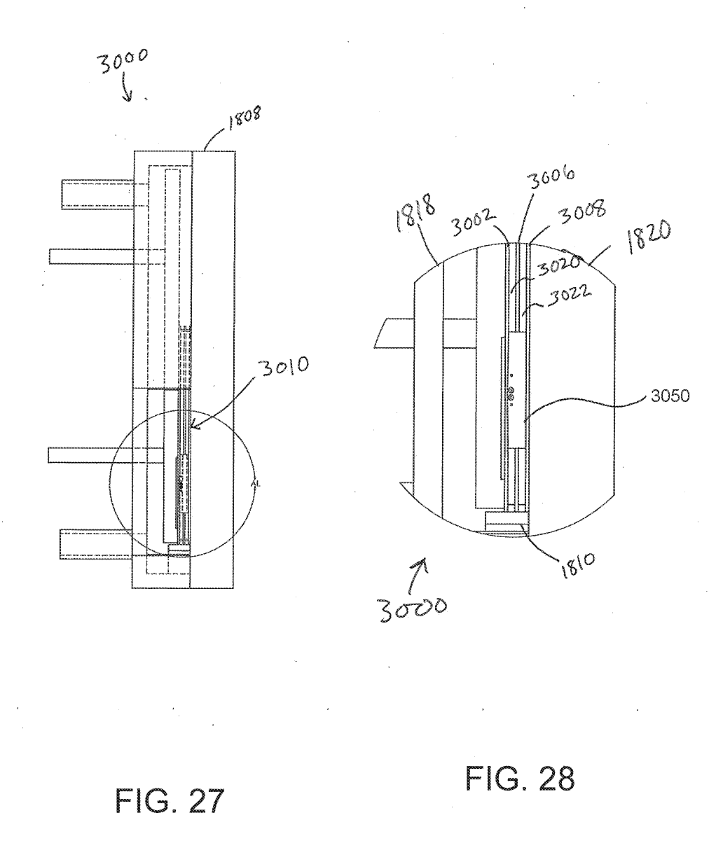

As another example, an unsealed triple pane IGU assembly 3010 shown in FIG. 27 can be filled with an interpane gas using a triple pane filling device 3050 as shown in FIGS. 27-28. The filling device 3050 has the form of a wedge filling block similar in some respects to filling devices described elsewhere herein. The descriptions of those embodiments also describe similar features of the filling device 3050 as applicable.

According to an embodiment, the filling device 1850 from the example in FIGS. 13-14 can also be used to fill the triple pane IGU 3002 as an alternative to the filling device 3050 and other filling devices and options. For example, the intermediate sheet 3006 and the first sheet 3002 shown in FIGS. 26-28 can be pressed together around the filling device 1850 in the same manner as the first and second sheets of IGU 1814 are pressed together around the filling device 1850.

According to some embodiments, filling and/or sealing the unsealed triple pane IGU assembly 3010 can be similar in some respects to filling and/or sealing the double pane IGU 1814 described elsewhere herein. U.S. Publ. No. 2017/0299121 provides additional details and teachings about filling and sealing an unsealed triple pane IGU, the relevant portion of which is herein incorporated by reference.

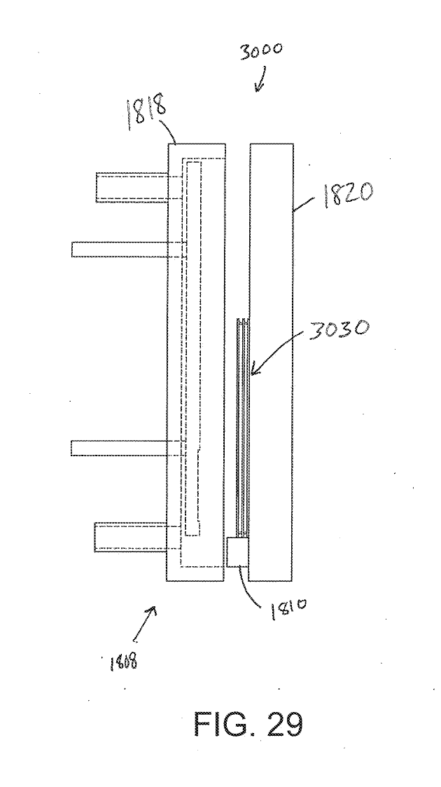

Turning to FIG. 29, the vacuum enclosure 3000 is shown in an open configuration with a sealed triple pane IGU 3030 ready to exit the chamber according to an embodiment.

According to various embodiments, an unsealed triple pane IGU can be formed within a vacuum chamber using a multi-step approach similar in some respects to the process described with respect to FIGS. 4-12. As an initial step, the method of forming the unsealed triple pane IGU assembly includes forming an unsealed double pane IGU assembly as taught in FIGS. 4-12. At an appropriate point in the process the assembly plate 1852 presses the first sheet 1830 against the IGU subassembly 1828 to at least partially seal the first sheet 1830 to the spacer frame 1832.

According to various embodiments, at this point the assembly plate 1852 positively engages and holds the resulting double pane IGU assembly and moves it away from the support structure 1810 by creating a vacuum between the assembly plate and the first sheet 1830. Once moved away, another IGU subassembly includes a second spacer frame sealed to another sheet can be moved onto the support structure 1818 within the vacuum enclosure. Once in place, the assembly plate 1852 can then position and seal at least part of the double pane IGU assembly to the second subassembly in the same manner used to form the double pane IGU assembly. For example, the double pane IGU assembly can be positioned next to the second subassembly on the support structure such that the double pane IGU assembly leans against the spacer frame in the second subassembly. The leaning assembly and the second subassembly can eventually be pressed together and sealed to form the triple pane IGU assembly.

As described elsewhere herein and in U.S. Publ. No. 2017/0299121, there are several options for providing an unsealed IGU assembly, which involve forming one or more fluid communication passages of various natures to the interpane space in an unsealed IGU assembly. As one example, the unsealed IGU assembly can be a partially assembled IGU that optionally has a tent configuration as described above.

In another example of an unsealed IGU assembly, an IGU passage to the interpane space is defined through an opening or hole in the spacer frame, where the sheets are both sealed to the spacer frame along a perimeter of the spacer frame. An example of such an IGU assembly is shown in FIGS. 47-56 of U.S. Publ. No. 2017/0299121. In this type of implementation, a first sheet can be provided in the chamber and moved away from the support structure as in the embodiments described above. Next, an IGU subassembly is moved into the interior of the vacuum enclosure. According to an embodiment the subassembly includes a second sheet sealed to a spacer frame. The spacer frame can have a hole defined therein.

In some cases the hole can be a pre-drilled hole in that it is present before the subassembly enters the chamber. Once the subassembly is in position within the chamber, forming the unsealed IGU assembly can include moving the first sheet held by the assembly plate toward the subassembly and pressing the first sheet against the spacer frame. The spacer frame can have a sealant pre-applied to its perimeter edge in order to adhere to the first sheet.

In another embodiment, the hole can be drilled within the chamber. Forming the unsealed IGU assembly in this type of implementation could involve moving the IGU subassembly into the chamber and pressing and sealing the first sheet to the spacer frame. The assembly plate can secure the IGU by pressing the IGU against the back plate. A drill or saw or punch mounted to an actuator inside or outside of the chamber could then be operated to cut the opening in the spacer frame in order to turn the sealed IGU into an unsealed IGU.

In yet another example of an unsealed IGU assembly, an IGU passage is defined through an opening or hole in the first or second sheet. The opening can be located close to an edge and/or corner of one of the first and second sheets.

In yet another example, the unsealed IGU assembly is a wedge-sealed IGU where a filling block is positioned between the glass sheets outside of a perimeter of the spacer frame. The filling block causes a wedge-passage to be defined between the spacer and one of the sheets. The filling block defines a filling block passage that is in fluid communication with the wedge-passage. One example of such an embodiment is shown in FIGS. 28-29 U.S. Publ. No. 2017/0299121. In various embodiments, the filling block is pressed against the spacer during the manufacturing process. In some examples, the face of the filling block that contacts the spacer includes a foam layer or other compressible material to improve the seal formed between the filling block and the spacer.

In various embodiments, a filling device can be used for forming a wedge-sealed IGU defining a wedge-passage.

In still another embodiment, the unsealed IGU assembly can include a filling block positioned between a glass sheet and the spacer, causing a passage to be defined between the spacer and the glass sheet.

As mentioned elsewhere in this disclosure, FIGS. 30-33 depict various components of an IGU gas filling system 5900 according to various embodiments. FIG. 30 is a front view of the system, which illustrates the spatial arrangement of some components. The system includes a vacuum chamber or vacuum enclosure 5904, which is positioned between a pre-chamber staging or assembly area and structure 5930 and a post-chamber structure 5932 that serves as a post-filling area.

Each of the pre- and post-chamber areas includes mechanical means for moving IGU assemblies into and out of the vacuum enclosure 5904. According to various embodiments, the sheets of glass material and IGU subassemblies are placed on the pre-chamber structure 5930, supported by an actuating mechanism 5940 that is configured to automatically move the components into an interior 5906 of the enclosure. In an embodiment, the actuating mechanism is a conveyor 5940, such as a belt conveyor. The components are moved within the enclosure using another support structure 5942, which is fully contained within the enclosure and in the depicted embodiment also includes one, two, or more linear conveyors 5942. After the sheets of glass material and IGU subassemblies are moved into the enclosure interior 5906, the components can be assembled to form an unsealed IGU assembly in a manner similar to other examples described herein. According to some embodiments, the unsealed IGU assemblies are also evacuated and filled with a gas within the chamber. After evacuation and filling, the IGUs are moved out of the enclosure to the post-chamber structure 5932 using another movable support structure 5944, which in this embodiment is also a conveyor.

FIG. 31 is a left side view of the vacuum enclosure 5904, depicting a first portion 5920 and a second portion 5922 that define an interior 5906 of the chamber 5904, according to an embodiment. In the embodiment shown in FIG. 31, the second portion 5922 is a fixed portion that includes a back plate and the movable support structure 5942 (e.g., conveyor) attached thereto. Correspondingly, the first portion 5920 is a movable portion configured to move toward and seal with the second fixed portion 5922 to create a sealed space in the interior 5906 of the enclosure for evacuating air from the enclosure and an interpane space of the IGUs, as well as for filling the interpane spaces with one or more gases.

As shown in FIG. 33, the movable first portion 5920 includes an assembly plate 5950 that is also configured as a press plate. As discussed elsewhere herein, the assembly plate 5950 includes openings or holes 5962 for generating a vacuum between the assembly plate and a sheet of glass material, such as the first sheet 6002 shown in FIG. 31. The assembly plate 5950 can then be used to position the sheet 6002 next to an IGU subassembly 6004 that is positioned on the support structure 5942 to form an unsealed, tented IGU assembly 6000.

As a press plate, the assembly plate 5950 is configured to move toward and press the partially assembled IGU 6000 together as discussed elsewhere herein. According to an embodiment, the openings 5962 in the assembly plate are used for introducing a gas into the interior of the enclosure. A gas supply apparatus 5964 forms part of a gas supply or gas source for the system. The gas supply apparatus includes a gas ram, which in some cases includes a volumetric actuator such as an actuating cylinder.

FIG. 32 is a right perspective view of the IGU gas filling system 5900, showing the post-chamber support structure 5932, which is configured to receive filled, and optionally sealed, IGU assemblies from the interior of the enclosure 5904.

FIG. 33 is an enlarged view of the left side (from the orientation of FIG. 30) of the moveable first portion 5920 and the gas supply apparatus 5964. The gas supply apparatus 5964 is mounted on the moveable first portion 5920 as seen in FIG. 30. In other examples, the gas supply apparatus 5964 is mounted on the second portion of the vacuum enclosure instead or on other equipment.

Throughout the drawings and description, like reference numbers are used to refer to similar or identical parts.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration to. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this technology pertains. All publications and patent applications are herein incorporated by reference to the same extent as if each individual publication or patent application was specifically and individually indicated by reference.

The technology has been described with reference to various specific and preferred embodiments and techniques. However, it should be understood that many variations and modifications may be made while remaining within the spirit and scope of the technology.

1. A method for manufacturing a sealed insulating glass unit (IGU), comprising:
providing a first sheet of glass material on a support structure in an interior of an open vacuum enclosure, the vacuum enclosure comprising a first portion, a second portion, and an assembly plate;
moving the first sheet away from the support structure with the assembly plate;
moving an IGU subassembly into the open vacuum enclosure, the IGU subassembly comprising a second sheet of glass material and a spacer frame sealed to the second sheet;
forming an unsealed IGU assembly within the vacuum enclosure, the unsealed IGU assembly comprising the first sheet at least partially sealed to the IGU subassembly, the unsealed IGU assembly defining an interpane space located between the first and second sheets and an IGU passage providing fluid communication between the interpane space and the interior of the vacuum enclosure;
sealing the first and second portions of the vacuum enclosure while the vacuum enclosure contains the first sheet and the IGU subassembly;
evacuating air from the sealed vacuum enclosure and from the unsealed IGU assembly;
introducing a gas into the interpane space through at least a portion of the IGU passage; and
closing the IGU passage to seal the interpane space.

2. The method of claim 1, wherein the second portion of the vacuum enclosure is fixed and the first portion of the vacuum enclosure is movable relative to the second portion, and wherein moving the first sheet away from the support structure with the assembly plate comprises moving the first sheet relative to the first portion.

3. The method of claim 1, wherein moving the first sheet away from the support structure with the assembly plate comprises lifting the first sheet with the assembly plate and moving the first sheet away from the support structure with the assembly plate.

4. The method of claim 3, further comprising creating a vacuum between the assembly plate and the first sheet to hold the first sheet against the assembly plate before lifting the first sheet with the assembly plate.

5. The method of claim 4, wherein forming the unsealed IGU assembly within the vacuum enclosure comprises moving the first sheet next to the IGU subassembly with the assembly plate and removing the vacuum between the assembly plate and the first sheet, thereby positioning the first sheet on the support structure next to the IGU subassembly.

6. The method of claim 5, wherein positioning the first sheet next to the IGU subassembly comprises leaning the first sheet against the IGU subassembly.

7. The method of claim 6, wherein removing the vacuum releases the first sheet onto the support structure such that a top edge of the first sheet contacts the IGU subassembly and a bottom edge of the first sheet is spaced apart from the IGU subassembly.

8. The method of claim 1, wherein sealing the first and second portions of the vacuum enclosure occurs before forming the unsealed IGU assembly within the vacuum enclosure.

9. The method of claim 1, wherein sealing the first and second portions of the vacuum enclosure occurs after forming the unsealed IGU assembly within the vacuum enclosure.

10. A method for making an insulating glass unit (IGU) assembly, comprising:
moving a first sheet of glass material onto a support structure in an interior of an open vacuum enclosure, the vacuum enclosure comprising a first portion, a second portion, and an assembly plate;
creating a vacuum between the assembly plate and the first sheet to hold the first sheet against the assembly plate;
lifting the first sheet with the assembly plate and moving the first sheet away from the support structure with the assembly plate;
moving an IGU subassembly onto the support structure within the open vacuum enclosure, the IGU subassembly comprising a second sheet of glass material and a spacer frame sealed to the second sheet; and
forming an unsealed IGU assembly within the vacuum enclosure, comprising:
moving the first sheet with the assembly plate to be next to the IGU subassembly within the vacuum enclosure; and
removing the vacuum between the assembly plate and the first sheet to position the first sheet on the support structure next to the IGU subassembly;
wherein the unsealed IGU assembly defines an interpane space located between the first and second sheets and an IGU passage providing fluid communication between the interpane space and the interior of the vacuum enclosure.

11. The method of claim 10, wherein forming the unsealed IGU assembly further comprises pressing and sealing the first sheet against at least part of the IGU subassembly with the assembly plate.

12. The method of claim 10, further comprising:
sealing the first and second portions of the vacuum enclosure while the vacuum enclosure contains the first sheet and the IGU subassembly;
evacuating air from the sealed vacuum enclosure and from the unsealed IGU assembly;
introducing a gas into the interpane space through at least a portion of the IGU passage; and
closing the IGU passage to seal the interpane space.

13. A system for assembling and filling an insulating glass unit (IGU) with an interpane gas, comprising:
a vacuum enclosure comprising a first portion and a second portion configured to selectively seal together to define a sealed interior of the vacuum enclosure;
a first vacuum source in selective fluid communication with the sealed interior of the vacuum enclosure;
a gas supply in selective fluid communication with the vacuum enclosure; and
an assembly plate system, comprising an assembly plate carried by the first portion, and an actuating system coupled to the assembly plate;
wherein the second portion comprises a support plate and a support structure adjacent to the support plate within the vacuum enclosure;
wherein the assembly plate system is configured to move a first sheet of glass material supported by the support structure within the vacuum enclosure away from the support structure;
wherein the support structure is configured to receive and support an IGU subassembly within the vacuum enclosure after the assembly plate system moves the first sheet away from the support structure, the IGU subassembly comprising a second sheet of glass material and a spacer frame sealed to the second sheet;
wherein the assembly plate system is configured to position the first sheet next to the IGU subassembly supported by the support structure as part of forming an unsealed IGU assembly;
wherein the unsealed IGU assembly comprises the first sheet at least partially sealed to the IGU subassembly and defines an interpane space between the first and second sheets and an IGU passage providing fluid communication between the interpane space and the sealed interior of the vacuum enclosure; and
wherein the selective fluid communication for the gas supply is configured for filling at least one of the sealed interior of the vacuum enclosure and the interpane space of the unsealed IGU assembly with the gas supply.

14. The system of claim 13, wherein the actuating system provides the assembly plate with a range of movement relative to the first portion, the second portion, and the support plate.

15. The system of claim 13, wherein the assembly plate system further comprises a second vacuum source in selective fluid communication with a plurality of openings in the assembly plate for creating a vacuum between the assembly plate and the first sheet.

16. The system of claim 13, wherein the support plate is angled away from a vertical axis of the vacuum enclosure.
